(19) United States
(12) Patent Application Publication
(10) Pub. No.: US 2026/0299391 A1
(43) Pub. Date: Oct. 1, 2026

(54) PROJECTION DEVICE AND ELECTRONIC DEVICE COMPRISING SAME

(71) Applicant: LG INNOTEK CO., LTD., Seoul (KR)

(72) Inventor: Ho Jin PARK, Seoul (KR)

(21) Appl. No.: 19/163,265

(22) PCT Filed: Mar. 6, 2024
(86) PCT No.: PCT/KR2024/002893

§ 371 Date: Sep. 8, 2025

(30) Foreign Application Priority Data
Mar. 6, 2023 (KR) 10-2023-0029413
Mar. 15, 2023 (KR) 10-2023-0033847
Mar. 17, 2023 (KR) 10-2023-0035326
Mar. 6, 2024 (KR) 10-2024-0031760
Mar. 6, 2024 (KR) 10-2024-0031761
Mar. 6, 2024 (KR) 10-2024-0031833

(51) Int. Cl. G03B 21/20

(52) U.S. Cl. CPC G03B 21/208; G03B 21/2066

(57) ABSTRACT

Disclosed in an embodiment is a projection device comprising: a light source unit; an optical modulator for modulating light emitted from the light source unit; a diffusion unit disposed between the optical modulator and the light source unit; an intermediate lens disposed between the diffusion unit and the light source unit; and a rear lens disposed between the diffusion unit and the optical modulator, wherein a stop is positioned between the light source unit and the optical modulator.

### TECHNICAL FIELD

Embodiments relate to a projection device and an electronic device including the same.

### BACKGROUND ART

Virtual reality (VR) refers to a specific environment, situation, or technology itself that resembles reality created by artificial technology using computers or the like but is not real. Augmented reality (AR) refers to a technology that combines virtual objects or information with a real environment to make it look like objects existing in the original environment.

Mixed reality (MR) or hybrid reality refers to the merging of the virtual worlds and real worlds to create new environments or new information. In particular, it is called mixed reality when it is possible to interact in real time between what exists in reality and what exists in the virtual in real time.

At this time, the created virtual environment, situation, or the like stimulates the user's five senses and enables spatial and temporal experiences similar to those of the real world, thereby enabling users to travel freely across the boundaries between reality and imagination. In addition, users can not only immerse themselves in such environments but also interact with the elements realized in such environments, such as adding operations and providing instructions using devices existing in the real space.

Recently, research on equipment (including gears and devices) used in this field of technology has been actively conducted. However, there is a growing demand for miniaturization and improvement of optical performance in such devices.

### DISCLOSURE

### Technical Problem

Embodiments are directed to providing a projection device and an electronic device including the same, which are used in augmented reality (AR) and the like and configured to provide well-mixed white light to a light modulator by disposing a diffusion unit at a position of a stop.

Embodiments are also directed to providing a projection device and an electronic device that are miniaturized and made compact through a light source of a single panel and a diffusion unit.

Embodiments are also directed to providing a projection device and an electronic device in which aberration performance is improved by configuring respective components to have different effective diameters.

Embodiments are also directed to providing a miniaturized projection device and an electronic device by adjusting a shape of a light source-side surface of an intermediate lens to minimize a distance between a light source unit and the intermediate lens.

Objectives to be solved by the embodiment are not limited to the above-described objectives and will include objectives and effectiveness which may be identified by solutions for the objectives and the embodiments described below.

### Technical Solution

A projection device according to an embodiment includes a light source unit, a light modulator configured to modulate light emitted from the light source unit, a diffusion unit disposed between the light source unit and the light modulator, an intermediate lens disposed between the diffusion unit and the light source unit, and a rear lens disposed between the diffusion unit and the light modulator, wherein a position of a stop is located between the light source unit and the light modulator.

The diffusion unit may be disposed at or adjacent to the position of the stop.

The projection device may include a reflection unit disposed between the rear lens and the light modulator, and a prism disposed between the light modulator and the reflection unit.

The intermediate lens may include a first surface facing the light source unit and a second surface facing the light modulator, and the rear lens may include a third surface facing the light source unit and a fourth surface facing the light modulator.

The second surface may be disposed apart from the diffusion unit.

A separation distance between the second surface and the diffusion unit may be smaller than a distance between the diffusion unit and the rear lens.

The first surface may be convex or concave toward the light source unit.

The second surface may be convex toward the light modulator.

A size of a radius of curvature of the first surface may be greater than a size of a radius of curvature of the second surface.

The third surface may convex toward the light source unit.

The fourth surface may convex toward the light modulator.

An optical axis of the light emitted from the light source unit may form an angle of 42° to 48° with a reflective surface of the reflection unit.

A distance from the light source unit to the second surface may be in a range of 5.5 mm to 9 mm.

A distance from the third surface to the reflection unit may be in a range of 5 mm to 12 mm.

A distance from the fourth surface to the reflection unit may be greater than a distance from the light source unit to the first surface or from the light source unit to the second surface.

A projection device according to an embodiment includes a light source unit, a light modulator configured to modulate light emitted from the light source unit, a diffusion unit disposed between the light source unit and the light modulator, an intermediate lens disposed between the diffusion unit and the light source unit, a first rear lens disposed between the diffusion unit and the light modulator, and a second rear lens disposed between the first rear lens and the light modulator, wherein an effective diameter of the first rear lens is greater than an effective diameter of the second rear lens.

An effective diameter of a reflection unit-side surface of the first rear lens may be greater than an effective diameter of a light source-side surface of the second rear lens.

A ratio of the effective diameter of the reflection unit-side surface of the first rear lens to the effective diameter of the light source-side surface of the second rear lens may be in a range of 1:3.4 to 1:4.1.

The projection device may include a reflection unit disposed between the second rear lens and the light modulator, and a prism disposed between the light modulator and the reflection unit.

A separation distance between the diffusion unit and the first rear lens may be greater than at least one of a separation distance between the intermediate lens and the diffusion unit, a separation distance between the first rear lens and the second rear lens, and a separation distance between the second rear lens and the reflection unit.

The separation distance between the diffusion unit and the first rear lens may be in a range of 1 mm to 5 mm.

A size of the diffusion unit may be smaller than a maximum effective diameter of at least one of the intermediate lens and the first rear lens.

The effective diameter of the first rear lens may be greater than an effective diameter of the reflection unit.

A refractive index of the intermediate lens may be smaller than a refractive index of each of the first rear lens and the second rear lens.

The diffusion unit may be disposed at or adjacent to a position of a stop.

A light source-side surface of the intermediate lens may be convex or concave toward the light source unit.

A reflection unit-side surface of the intermediate lens may be convex toward the reflection unit.

A size of a radius of curvature of the light source-side surface of the intermediate lens may be greater than a size of a radius of curvature of the reflection unit-side surface of the intermediate lens.

A light source-side surface of the first rear lens may be convex toward the light source unit.

A reflection unit-side surface of the first rear lens may be convex toward the reflection unit.

A projection device according to an embodiment includes a light source unit, a light modulator configured to modulate light emitted from the light source unit, a diffusion unit disposed between the light modulator and the light source unit, an intermediate lens disposed between the diffusion unit and the light source unit, a rear lens disposed between the diffusion unit and the light modulator, and a reflection unit disposed between the rear lens and the light modulator, wherein an absolute value of a radius of curvature of a light source-side surface of the intermediate lens is infinite, and a separation distance between the light source unit and the intermediate lens is smaller than a separation distance between the rear lens and the reflection unit. The separation distance refers to a spacing between facing surfaces. When the absolute value of the radius of curvature of the light source-side surface of the intermediate lens is 60 or more, the absolute value is regarded as infinite.

The separation distance between the light source unit and the intermediate lens may be smaller than a separation distance between the reflection unit and the light modulator. The separation distance refers to a spacing between facing surfaces. When the absolute value of the radius of curvature of the light source-side surface of the intermediate lens is 60 or more, the absolute value is regarded as infinite.

The diffusion unit may be disposed at or adjacent to a position of a stop.

The projection device may include a reflection unit disposed between the rear lens and the light modulator, and a prism disposed between the light modulator and the reflection unit.

A reflection unit-side surface of the intermediate lens may be convex toward the light source unit, and an absolute value of a radius of curvature of the reflection unit-side surface of the intermediate lens may be 3 or less.

The reflection unit-side surface of the intermediate lens may be convex toward the light source unit, and the separation distance between the light source unit and the intermediate lens may be 3 mm or less.

The projection device may include a housing disposed at an outermost side, and a volume of the housing may be 4 cc or less.

A distance from the rear lens to the reflection unit may be greater than each of the distance between the light source unit and the intermediate lens, a distance between the intermediate lens and the diffusion unit, and a distance between the diffusion unit and the rear lens.

The reflection unit-side surface of the intermediate lens may be disposed apart from the diffusion unit.

A separation distance between the reflection unit-side surface of the intermediate lens and the diffusion unit may be smaller than the distance between the diffusion unit and the rear lens.

The light source-side surface of the intermediate lens may be convex or concave toward the light source unit.

The reflection unit-side surface of the intermediate lens may be convex or concave toward the light modulator,

### Advantageous Effects

Embodiments can implement a projection device and an electronic device including the same, which are used in augmented reality (AR) and the like and configured to provide well-mixed white light to a light modulator by disposing a diffusion unit at a position of a stop.

Further, embodiments can implement a projection device and an electronic device that are miniaturized and made compact through a light source of a single panel and a diffusion unit.

Further, embodiments can implement a projection device and an electronic device in which aberration performance is improved by configuring respective components to have different effective diameters.

Further, embodiments can implement a miniaturized projection device and an electronic device by adjusting a shape of a light source-side surface of an intermediate lens to minimize a distance between a light source unit and the intermediate lens.

Various advantages and effects of the present invention are not limited to the above description and can be more easily understood through the description of specific exemplary embodiments of the present invention.

### DESCRIPTION OF DRAWINGS

FIG. 1 is a block diagram illustrating a configuration of an extended reality electronic device according to an embodiment of the present invention.

FIG. 2 is a perspective view of an augmented reality electronic device according to an embodiment of the present invention.

FIG. 3 is a perspective view of a projection device according to the embodiment.

FIG. 4 is an exploded perspective view of the projection device according to the embodiment.

FIG. 5 is a cross-sectional view taken along line AA′ in FIG. 3.

FIGS. 6 and 7 are views of the projection device according to the embodiment with a housing removed.

FIG. 8 is an optical system of an illuminating system in a projection device according to a first embodiment of the present invention,

FIG. 9 is a diagram for describing effects of the optical system of the illuminating system in the projection device according to the embodiment of the present invention.

FIG. 10 is a diagram showing simulation results of a stop, a diffusion unit, and a light modulator in the projection device according to the embodiment of the present invention.

FIG. 11 is an optical system of an illuminating system in a projection device according to a second embodiment of the present invention.

FIG. 12 is another example of FIG. 5.

FIG. 13 is an optical system for an illuminating system in a projection device according to a third embodiment of the present invention.

FIG. 14 is an optical system for an illuminating system in a projection device according to a fourth embodiment of the present invention.

FIG. 15 is an optical system for an illuminating system in a projection device according to a fifth embodiment of the present invention.

FIG. 16 is still another example of FIG. 5.

FIG. 17 is an optical system for an illuminating system in a projection device according to a sixth embodiment of the present invention.

FIG. 18 is an optical system for an illuminating system in a projection device according to a seventh embodiment of the present invention.

### MODES OF THE INVENTION

Hereinafter, exemplary embodiments of the present invention will be described in detail with reference to the accompanying drawings.

However, the technical spirit of the present invention is not limited to some embodiments which will be described and may be implemented in various forms, and one or more elements in the embodiments may be selectively combined and replaced to be used within the scope of the technical spirit of the present invention.

Further, the terms used in the embodiments of the present invention (including technical and scientific terms), may be interpreted with meanings that are generally understood by those skilled in the art unless particularly defined and described, and terms which are generally used, such as terms defined in a dictionary, may be understood in consideration of their contextual meanings in the related art.

Further, the terms used in the embodiments of the present invention are provided only to describe embodiments of the present invention and not for purposes of limitation.

In the present specification, unless clearly indicated otherwise by the context, singular forms include the plural forms thereof, and in a case in which “at least one (or one or more) among A, B, and C” is described, this may include at least one combination among all possible combinations of A, B, and C.

In addition, terms such as first, second, A, B, (a), (b), and the like may be used to describe components of the embodiments of the present invention.

These terms are only provided to distinguish the components from other components, and the essence, sequence, order, or the like of the components is not limited by the terms.

In addition, when a component is described as being “connected,” “coupled,” or “linked” to another component, the component may not only be directly connected, coupled, or linked to the other component but may also be connected, coupled, or linked to the other element by still another component between the component and the other component.

Further, when a component is described as being formed “on (above)” or “under (below)” another component, the term “on (above)” or “under (below)” includes both of a case in which the two components are in direct contact with each other and a case in which one or more components are (indirectly) disposed between the two components. In addition, when a component is described as being disposed “on or under” another component, such a description may include a case in which the component is disposed at an upper side or a lower side with respect to another component.

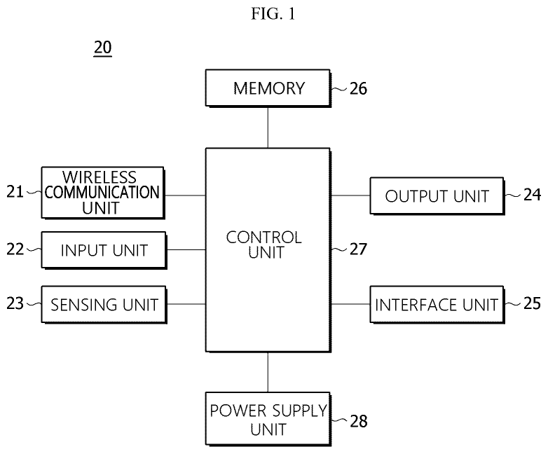

FIG. 1 is a block diagram illustrating a configuration of an extended reality electronic device according to an embodiment of the present invention.

Referring to FIG. 1, an extended reality electronic device 20 may include a wireless communication unit 21, an input unit 22, a sensing unit 23, an output unit 24, an interface unit 25, a memory 26, a control unit 27, a power supply unit 28, and the like. It is understood that implementing all the components illustrated in FIG. 1 is not a requirement for the electronic device 20, and that the electronic device 20 described in the present specification may alternatively be implemented by more or fewer components.

More specifically, among the above components, the wireless communication unit 21 may include one or more modules that allow wireless communication between the electronic device 20 and a wireless communication system, between the electronic device 20 and another electronic device, or between the electronic device 20 and an external server. Further, the wireless communication unit 21 may include one or more modules that connect the electronic device 20 to one or more networks.

The wireless communication unit 21 may include at least one of a broadcast receiving module, a mobile communication module, a wireless Internet module, a short-range communication module, and a position information module.

The input unit 22 may include a camera or an image input unit for receiving image signals, a microphone or an audio input unit for receiving audio signals, or a user input unit, for example, touch keys, push keys (mechanical keys), or the like for receiving information from the user. Audio data or image data obtained by the input unit 22 may be analyzed and processed by user control commands.

The sensing unit 23 may include one or more sensors for sensing at least one of internal information of the electronic device 20, information about a surrounding environment of the electronic device 20, and user information.

For example, the sensing unit 23 may include at least one of a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, an ultrasonic sensor, an optical sensor (e.g., a capturing device), a microphone, a battery gauge, an environmental sensor (e.g., a barometer, a hygrometer, a thermometer, a radiation detection sensor, a thermal sensor, a gas sensor, or the like), and a chemical sensor (e.g., an electronic nose, a health care sensor, a biometric sensor, or the like). Meanwhile, the electronic device 20 described in the present specification may utilize a combination of information obtained from at least two or more of these sensors.

The output unit 24 may be configured to output various types of information related to vision, hearing, or tactile sensations, and may include at least one of a display unit, an audio output unit, a haptic module, or an optical output unit. The display unit may have an inter-layered structure or an integrated structure with a touch sensor to implement a touch screen. The touch screen may provide an output interface between the augmented reality electronic device 20 and the user, as well as function as a user input unit that provides an input interface between the augmented reality electronic device 20 and the user.

The interface unit 25 serves as an interface with various types of external devices that are connected to the electronic device 20. Through the interface unit 25, the electronic device 20 may receive virtual reality or augmented reality content from an external device, and perform mutual interaction by exchanging various input signals, sensing signals, and data.

For example, the interface unit 25 may include at least one of wired/wireless headset ports, external charger ports, wired/wireless data ports, memory card ports, ports for connecting a device having an identification module, audio input/output (I/O) ports, video input/output (I/O) ports, and earphone ports.

Further, the memory 26 stores data supporting various functions of the electronic device 20. The memory 26 may store a plurality of application programs or applications executed in the electronic device 20, and data or instructions for operations of the electronic device 20. At least some of these application programs may be downloaded from an external server via wireless communication. Further, at least some of these application programs may be present on the electronic device 20 at the time of shipment, which is typically the case for basic functions (e.g., receiving a call, placing a call, receiving a message, sending a message, and the like) of the electronic device 20.

The control unit 27 controls overall operations of the electronic device 20, in addition to the operations related to the application programs. The control unit 27 may process signals, data, information, and the like, which are input or output by the components described above.

In addition, the control unit 27 may execute an application stored in the memory 26 to control at least some of the components and provide appropriate information to the user or process functions. Furthermore, the control unit 27 may operate by combining at least two or more components included in the electronic device 20 to execute the application.

In addition, the control unit 27 may detect the movement of the electronic device 20 or the user by using a gyroscope sensor, a gravity sensor, a motion sensor, and the like included in the sensing unit 23. Alternatively, the control unit 27 may detect objects approaching the electronic device 20 or the user by using sensors such as a proximity sensor, a light sensor, a magnetic sensor, an infrared sensor, an ultrasonic sensor, or an optical sensor included in the sensing unit 23. In addition, the control unit 27 may also detect the movement of the user through sensors provided in a controller that operates in conjunction with the electronic device 20.

Further, the control unit 27 may perform operations or functions of the electronic device 20 using the application programs stored in the memory 26.

The power supply unit 28 receives external power and internal power and supplies power to the respective components included in the electronic device 20 under the control of the control unit 27. The power supply unit 28 includes a battery, which may be provided in \a built-in or replaceable form.

At least some of the respective components may operate in cooperation with one another to implement the operation, control, or control method of the electronic device according to various embodiments described below. Further, the operation, control, or control method of the electronic device according to various embodiments may be implemented on the electronic device by execution of at least one application program stored in the memory 26.

Hereinafter, the electronic device described as an example of the present invention will be described based on an embodiment applied to head mounted displays (HMDs). However, the embodiments of the electronic device according to the present invention may also include devices such as mobile phones, smart phones, laptop computers, terminals for digital broadcasting, personal digital assistants (PDAs), portable multimedia players (PMPs), navigation systems, slate personal computers (PCs), tablet PCs, ultra books, and wearable devices. The wearable devices may include, in addition to the HMDs, watch-type terminals (smartwatches), contact lenses, VR/AR/MR glasses, and the like.

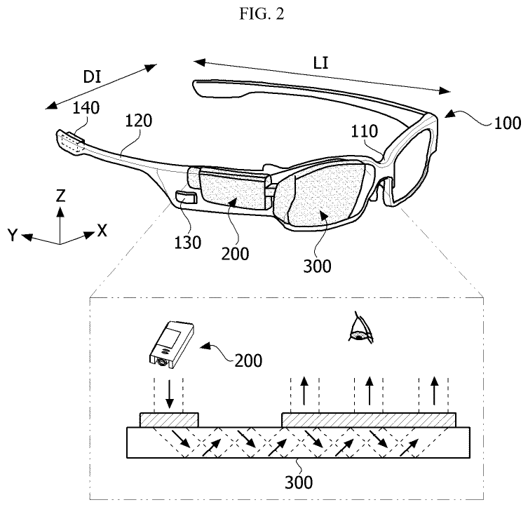

FIG. 2 is a perspective view of an augmented reality electronic device according to an embodiment of the present invention.

As shown in FIG. 2, the electronic device according to the embodiment of the present invention may include a frame 100, a projection device 200, and a display unit 300.

The electronic device may be provided as a glass type (smart glass). The glass-type electronic device may be configured to be worn on the head of the human body and may include the frame (a case, a housing, or the like) 100 therefor. The frame 100 may be formed of a flexible material to facilitate wearing.

The frame 100 is supported on the head and has a space in which various components are mounted. As illustrated in the drawing, electronic components such as the projection device 200, a user input unit 130, or an audio output unit 140 may be mounted on the frame 100. In addition, a lens covering at least one of a left eye and a right eye may be detachably mounted on the frame 100.

As illustrated in the drawing, the frame 100 may have the form of glasses worn on the face of the body of a user, but the present invention is not necessarily limited thereto, and the frame 100 may have a form such as goggles or the like, which are worn in close contact with the face of the user.

The frame 100 may include a front frame 110 having at least one opening and a pair of side frames 120 that extend in a y-direction (based on FIG. 2) intersecting the front frame 110 and are parallel to each other.

The frame 100 may have a length DI in the x-direction and a length LI in the y-direction, which may be the same as or different from each other.

The projection device 200 is provided to control various electronic components provided in the electronic device. The projection device 200 may be used interchangeably with a “light output device,” a “light projection device,” a “light irradiation device,” an “optical device,” and the like.

The projection device 200 may generate an image to be shown to the user or a video of continuous images. The projection device 200 may include an image source panel that generates an image and a plurality of lenses that diffuse and converge light generated from the image source panel.

The projection device 200 may be fixed to any one side frame 120 of two side frames 120. For example, the projection device 200 may be fixed to an inside or an outside of any one side frame 120 or embedded and integrally formed in any one side frame 120. Alternatively, the projection device 200 may be fixed to the front frame 110 or provided separately from the electronic device.

The display unit 300 may be implemented in the form of an HMD. The HMD form refers to a display scheme that is mounted on the head and displays a video directly in front of the user's eyes. When the user wears the electronic device, the display unit 300 may be disposed to correspond to at least one of the left eye and the right eye to provide the video directly in front of the user's eye. In this drawing, it is illustrated that the display unit 300 is located at a part corresponding to the right eye to output the video toward the right eye of the user. However, as described above, the display unit 300 is not thereto and may be disposed in front of both the left and right eyes.

The display unit 300 may allow the image generated by the projection device 200 to be displayed to the user while the user visually recognizes an external environment. For example, the display unit 300 may project the image to a display area using a prism.

In addition, the display unit 300 may be formed to be light-transmitting so that the projected image and a general field of view (a range visible to the user through their eyes) may be seen at the same time. For example, the display unit 300 may be semi-transparent and may be formed by an optical element including glass.

In addition, the display unit 300 may be inserted into and fixed to the opening included in the front frame 110 or located on a rear surface (i.e., between the opening and the user) of the opening to be fixed to the front frame 110. In the drawing, a case in which the display unit 300 is located on the rear surface of the opening and fixed to the front frame 110 is illustrated as an example, but unlike this, the display unit 300 may be disposed and fixed at various positions of the frame 100.

As shown in FIG. 2, in the electronic device, when image light from the projection device 200 for the image is incident on one side of the display unit 300, the image light is emitted to the other side through the display unit 300 to show the image generated by the projection device 200 to the user.

As a result, the user may view the image generated by the projection device 200 while simultaneously viewing the external environment through the opening of the frame 100. That is, the video output through the display unit 300 may appear to overlap with the general field of view. The electronic device may provide augmented reality (AR) in which a virtual image overlaps with an image or background of reality using the characteristics of the display to show one image.

Furthermore, in addition to the above operation, the external environment and the image generated by the projection device 200 may be provided to the user with a time difference within a short period of time that is not perceivable by humans. For example, within one frame, the external environment may be provided to the user during one section, while the video from the projection device 200 may be provided to the user during another section.

Alternatively, both overlap and time difference may be provided.

In addition, the projection device according to the embodiment may have a structure described below, or may be configured to further include a light guide and/or a glass on the described structure. In addition, the projection device may include a digital micromirror device (DMD) projector or a projection device.

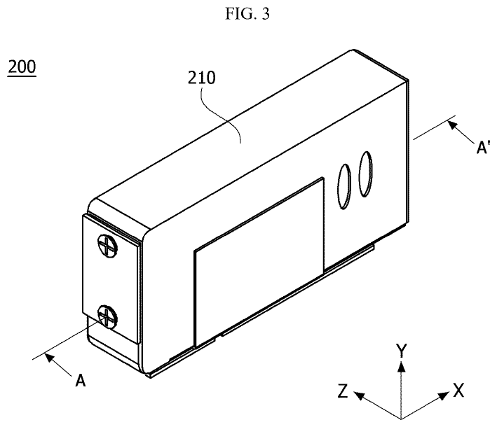

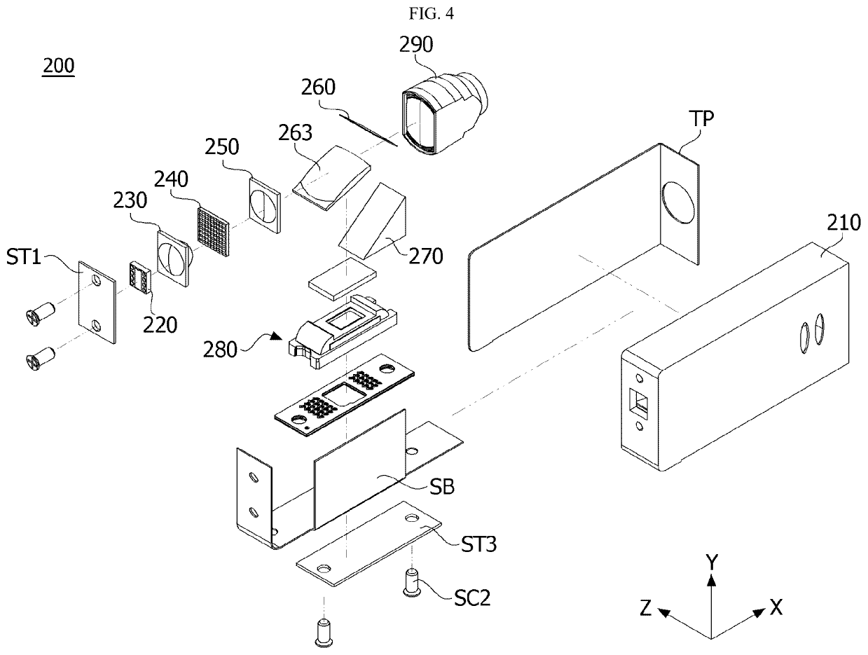

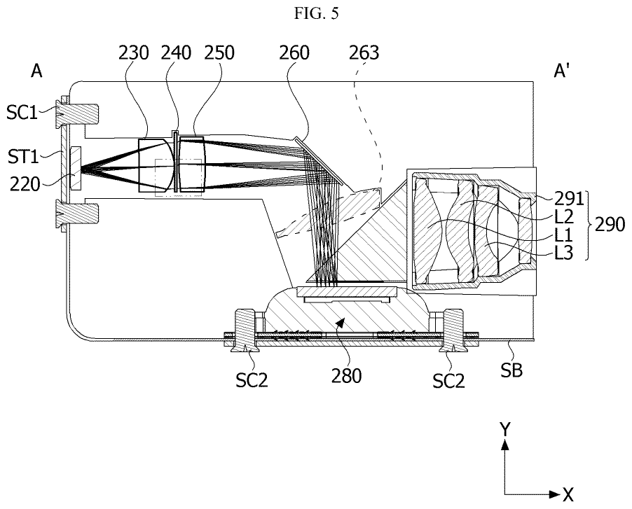

FIG. 3 is a perspective view of the projection device according to the embodiment, FIG. 4 is an exploded perspective view of the projection device according to the embodiment, and FIG. 5 is a cross-sectional view taken along line AA′ in FIG. 3.

Referring to FIGS. 3 to 5, the projection device 200 according to the embodiment may include a housing 210, a light source unit 220, an intermediate lens 230, a diffusion unit 240, a rear lens 250, a reflection unit 260, an additional lens 263, a prism 270, a light modulator 280, a projection lens unit 290, and a blocking member TP.

The housing 210 may have a space or a housing recess in which each component of the projection device 200 is accommodated or disposed. The housing 210 may be located on an outer side of the projection device 200. For example, the light source unit 220, the intermediate lens 230, the diffusion unit 240, the rear lens 250, the reflection unit 260, the additional lens 263, the prism 270, the light modulator 280, and the projection lens unit 290 may be disposed in the housing 210.

Further, the housing 210 may have a structure that is open on one side. Accordingly, each of the components described above may be assembled through the open area or surface. Furthermore, the blocking member TP, which will be described later, may be disposed on the open area or surface of the housing 210.

The housing 210 may have various shapes. For example, the housing 210 may have a hexahedral structure. Accordingly, the projection device according to the embodiment may be easily mounted on an electronic device. In addition, the projection device according to the embodiment may be easily miniaturized or made compact.

The light source unit 220 may be disposed in the housing 210. The light source unit 220 may be disposed adjacent to any one of outer side surfaces of the housing 210.

The light source unit 220 may include at least one light source. In the embodiment, the light source unit 220 may include one light source. For example, the light source unit 220 may use a light source formed of a single panel. That is, the light source unit 220 may include a light source of a single panel, which is composed of a light source that emits red, green, and blue light.

In another example, when the light source unit 220 includes a plurality of light sources, the plurality of light sources may be located adjacent to different surfaces. In addition, the plurality of light sources may emit light having different wavelength bands or colors. For example, the plurality of light sources may emit light of a green wavelength, or emit red and blue light. For example, the red, green, and blue light emitted from the respective light sources may correspond to light at their respective center wavelengths.

Further, in the projection device according to the embodiment, a first direction may correspond to an “X-axis direction” in the drawings. The first direction may correspond to a direction from the light source unit 220 toward the projection lens unit 290. Furthermore, a second direction may correspond to a Y-axis direction in the drawings. The second direction may be a direction perpendicular to the first direction. A third direction may be a direction perpendicular to the first direction and the second direction. In addition, the third direction may correspond to a “Z-axis direction” in the drawings.

The intermediate lens 230 may be disposed adjacent to the light source unit 220. The intermediate lens 230 may be located on the side of the light source unit 220 in the first direction (X-axis direction). Alternatively, the intermediate lens 230 may be located on the side of the light source unit 220 in a direction in which light is emitted from the light source unit 220.

In addition, the intermediate lens 230 may be disposed between the diffusion unit 240 and the light source unit 220.

The diffusion unit 240 may be disposed apart from the intermediate lens 230. The intermediate lens 230 may be located between the diffusion unit 240 and the light source unit 220, and the diffusion unit 240 may be located between the intermediate lens 230 and the rear lens 250. In addition, the diffusion unit 240 may be located between the intermediate lens 230 and the prism 270. In addition, the diffusion unit 240 may be located between the intermediate lens 230 and the light modulator 280. Alternatively, the diffusion unit 240 may be located between the light source unit 220 and the light modulator 280.

In addition, in the projection device according to the embodiment, a position of a stop may be located between the light source unit 220 and the light modulator 280. The stop is an optical stop, and may be located at the rear end of the intermediate lens 230. In particular, the position of the stop may be located between the intermediate lens 230 and the rear lens 250. Accordingly, the optical stop or the stop, may be an area in which light or a light bundle converges (or intersects). Accordingly, the position of the stop may correspond to a point at which light of different wavelengths intersect. For example, the stop may correspond to a position of an aperture. The stop may be an aperture stop (AS), a field stop (FS), or the like. Thus, the diffusion unit 240 may be located in an area in which light or rays of each color emitted from the light source unit 220 are combined into one, and the combined light may be provided to the light modulator 280 through the diffusion unit 240. That is, the miniaturization of the projection device through light collection may be more easily achieved, and even when a light source of a single panel is used, light loss may be suppressed despite the compactness, since the light bundle is collected and emitted through the diffusion unit.

Furthermore, the position of the stop may be present in each of an illuminating system and a projecting system. In the embodiment, the position of the stop is described based on the illuminating system.

The diffusion unit 240 may be a diffuser. For example, the diffusion unit 240 may include a micro lens array. Accordingly, the diffusion unit 240 may provide white light through diffuse reflection or the like. Furthermore, the diffusion unit 240 may be disposed adjacent to or at the position of the stop, thereby effectively diffusing the converged three-color light into white light.

The rear lens 250 may be located at the rear end of the diffusion unit 240. Accordingly, the diffusion unit 240 may be located between the intermediate lens 230 and the rear lens 250. Furthermore, the rear lens 250 may be located between the diffusion unit 240 and the light modulator 280. In addition, the rear lens 250 may be located between the diffusion unit 240 (or the light source unit or the intermediate lens) and the prism (or the reflection unit).

The rear lens 250 may be formed of a single lens or a plurality of lenses. For example, when the rear lens 250 is formed of a single lens, the size of the projection device (or the optical system) may be more easily reduced.

Further, when the rear lens 250 is formed of a plurality of lenses (e.g., two lenses), the light bundle may be focused so that defocused light is not incident on the light modulator. Accordingly, the efficiency of light incident on the light modulator may be improved, thereby providing a projection device with improved optical performance.

The intermediate lens 230 and the rear lens 250 may each include a relay lens and/or a collimator lens. For example, the intermediate lens 230 may be a collimator lens. In addition, the rear lens 250 may be a relay lens. Further, the intermediate lens 230 may be a collimator/relay lens. In addition, the rear lens 250 may be a relay/collimator lens.

The reflection unit 260 may be located at the rear end of the rear lens 250. The reflection unit 260 may be located on the side of the rear lens 250 in the first direction (X-axis direction). The reflection unit 260 may be disposed apart from the rear lens 250 in the first direction. The reflection unit 260 may be located between the rear lens 250 and the prism 270 (or the light modulator).

In addition, the reflection unit 260 may be inclined at a predetermined angle with respect to the rear lens 250. The reflection unit 260 may reflect light transmitted through the rear lens 250. For example, light that has passed through the rear lens 250 may be reflected by the reflection unit 260, change its path toward the projection lens unit, and then be reflected toward the prism or light modulator therebelow.

The reflection unit 260 may be inclined at a predetermined angle with respect to the rear lens 250, the first direction, or the like. With this configuration, a length of the projection device according to the embodiment in the second direction may be minimized.

The additional lens 263 may be disposed at the rear end of the reflection unit 260. However, the additional lens 263 may not be present as illustrated above. The additional lens 263 may be disposed below the reflection unit 260. The additional lens 263 may at least partially overlap the reflection unit 260 in the second direction.

The additional lens 263 may include a relay lens. The additional lens 263 may transmit light reflected from the reflection unit 260. The additional lens 263 may deliver light rays from one position to another. That is, the additional lens 263 may align or change the path of light rays. Furthermore, the additional lens 263 may adjust the size of illumination or an image (i.e., the maximum area of light rays) provided by the illuminating system, or may compensate for optical differences.

The prism 270 may be located at the rear end of the rear lens 250. Further, a prism 270 may be disposed at the rear end of the additional lens 263. In addition, the prism 270 may be located between the rear lens 250 and the light modulator 280. In addition, the prism 270 may be located between the reflection unit 260 and the light modulator 280. Furthermore, the prism 270 may be located below the additional lens 263 or the reflection unit 260. The prism 270 may partially overlap the additional lens 263 or the reflection unit 260 in the second direction. Furthermore, a partial area of the prism 270 may not overlap the additional lens 263 or the reflection unit 260 in the second direction. With this configuration, the prism 270 may transmit light emitted from (or transmitted through) the additional lens 263, and may reflect the transmitted light, which is incident on and re-emitted from the light modulator 280, toward the projection lens unit 290.

The prism 270 may include a total internal reflection (TIR) prism. As described above, the prism 270 may change a traveling direction of light rays. That is, the prism 270 may perform transmission and reflection of light rays. Specifically, the prism 270 may transmit light emitted (or transmitted through) from the reflection unit 260 (or the additional lens 263), and reflect light emitted from the light modulator 280. In addition, the prism 270 may transmit light emitted from the light source unit 220 and reflect light emitted from the light modulator 280. For example, the prism 270 may reflect the light emitted from the light modulator 280 to the projection lens unit 290. Accordingly, the path of light or a direction in which light travels may correspond to the first direction, may be changed to the opposite of the second direction by the reflection unit 260, and then may be redirected toward the first direction or the projection lens unit. With this configuration, miniaturization of the projection device according to the embodiment may be achieved.

The prism 270 may be located at the rear end of the prism 270 in the illuminating system. In addition, the prism 270 may be located at the rear end of the light modulator 280 in a projecting system. In other words, light emitted from a light source may sequentially pass through the intermediate lens 230, the diffusion unit 240, the rear lens 250, the reflection unit 260, (the additional lens 263), the prism 270, the light modulator 280, the prism 270, and the projection lens unit 290, and may finally be provided to a screen or a light guide (display unit).

Accordingly, the prism 270 may be disposed between the light modulator 280 and the projection lens unit 290 on the path of light. Further, the prism 270 may be disposed between the additional lens 263 and the light modulator 280.

In addition, the light modulator 280 may reflect incident light to project an image. For example, the light modulator 280 may emit or project a video or an image based on an image signal incident through a substrate SB. That is, the light modulator 280 may modulate light emitted from the light source unit 220.

The light modulator 280 according to the embodiment may include a DMD. In addition, the light modulator 280 may project an image by applying different weights to light of respective wavelengths. In the embodiment, the light modulator 280 may include a plurality of micromirrors. For example, each mirror may reflect or block light in response to a signal (e.g., a digital signal). In other words, the light modulator 280 may control the state of each mirror based on an image signal applied through the substrate SB, and may project an image corresponding to the image signal. For example, when light is reflected by controlling the mirror, a bright region of the image may be displayed, and when light is blocked, a dark region of the image may be displayed. In addition, the light modulator 280 may have a size of, for example, 3.456 mm×1.94 mm, with a diagonal length of approximately 0.16 inches.

The projection lens unit 290 may be disposed at the rear ends of the prism 270 and the light modulator 280. When light emitted from the light modulator 280 is reflected by the prism 270, the light reflected by the prism 270 may be incident on the projection lens unit 290. The above-described light may be projected through the projection lens unit 290. The projection lens unit 290 may project the light emitted from the projection device onto a screen or light guide (or the display unit).

In the embodiment, the projection lens unit 290 may adjust the size of the image so that light rays are incident within an effective stop diameter (entrance pupil diameter (EPD)) of a light guide or the like.

To this end, the projection lens unit 290 according to the embodiment may include a lens barrel 291 and a plurality of lenses L1 to L4 (or an optical system) disposed within the lens barrel.

The plurality of lenses L1 to L4 may at least partially overlap the prism 270 in the first direction.

The blocking member TP may be disposed on one outer side surface of the housing 210. Accordingly, the blocking member TP may be disposed outside each component after each component is accommodated in the housing 210. In the embodiment, the blocking member TP may be disposed on one side of the housing 210 corresponding to a groove of the housing 210. In addition, the blocking member TP may cover each component. With this configuration, the blocking member TP may effectively block the inflow of foreign substances or stray light into the components of the housing 210. Accordingly, image projection of the electronic device or the projection device may be more accurately implemented.

The projection device 200 according to the embodiment may further include the substrate SB, fastening members SC1 and SC2, and reinforcing plates ST1 and ST2.

The substrate SB may be electrically connected to the light source unit 220 and the light modulator 280. The light source unit 220 and the light modulator 280 may be disposed on the substrate SB. In addition, the substrate SB may be disposed in the housing 210. For example, the substrate SB may be disposed along the outer side surface of the housing 210.

Operations of the light modulator 280 and the light source unit 220 may be controlled through the substrate SB. The substrate SB may perform communication with a control unit or the like of an external device via wired or wireless communication. For example, a control signal from the outside may be transmitted to the projection device through the substrate SB. In addition, the projection device may output an image based on the transmitted control signal.

The fastening members SC1 and SC2 may be disposed on an outer side of the substrate SB. Accordingly, bonding strength among the substrate SB, the housing 210, the light source unit 220, and the light modulator 280 may be improved. Furthermore, since the substrate SB is disposed outside the housing 210, the degree of freedom in assembly or design may be increased.

The reinforcing plates ST1 and ST2 may be disposed on the outer side of the substrate SB. Furthermore, the reinforcing plates ST1 and ST2 may be stiffeners formed of various materials such as metal, composite materials, or resin (plastic). The reinforcing plates ST1 and ST2 may be disposed on the outer side of the substrate SB to improve the rigidity and strength of the substrate SB and the housing. For example, the reinforcing plates ST1 and ST2 may be disposed on the substrate SB in correspondence with the positions of the light source unit 220 and the light modulator 280. With this configuration, deformation due to heat or the like generated by the light source unit 220 and the light modulator 280 may be suppressed. Furthermore, the reinforcing plates ST1 and ST2 may protect the projection device from external impacts. In addition, the fastening members SC1 and SC2 may pass through the reinforcing plates ST1 and ST2. For example, the fastening members may pass through the respective reinforcing plates to improve the bonding strength between the substrate and the housing 210.

In a modified example, the reinforcing plate may be integrally formed to correspond to the substrate SB, rather than being provided as a plurality of reinforcing plates. That is, the reinforcing plate may have a structure extending from the light source unit 220 to the light modulator 280.

In addition, the substrate may be separately disposed to correspond to each of the light source and the light modulator. In addition, the fastening members may be disposed on a plurality of substrates, respectively. Alternatively, each fastening member may pass through all of the plurality of substrates. Accordingly, the plurality of substrates may be coupled to each other by one fastening member. As a result, the number of fastening members may be variously set to an odd or even number.

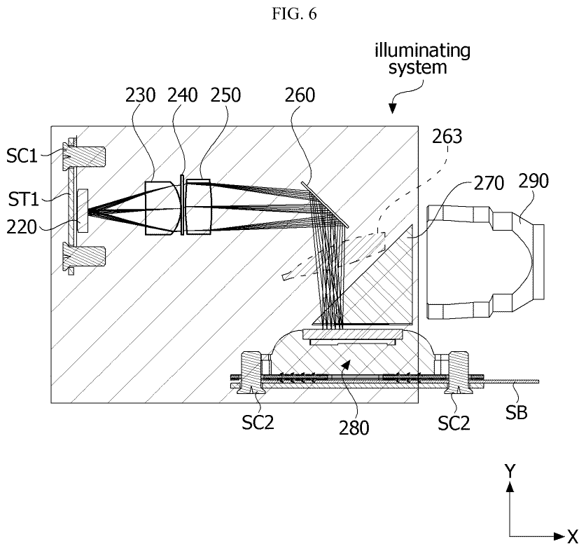

FIGS. 6 and 7 are views of the projection device according to the embodiment with the housing removed.

The projection device according to the embodiment may include an illuminating system and a projecting system (also referred to as a projection system, a projecting unit, a projection unit, a projecting part, or the like).

Referring to FIG. 6, the projection device may include the illuminating system. According to the embodiment, the illuminating system may include the housing 210, the light source unit 220, the intermediate lens 230, the diffusion unit 240, the rear lens 250, the reflection unit 260, the additional lens 263, and the prism 270. Furthermore, light emitted from the prism 270 in the illuminating system may be incident on the light modulator 280. Accordingly, the illuminating system may include up to the light modulator 280.

The illuminating system may include the prism 270 as a component thereof, receive light (illumination light) from the light source, and emit the light in a predetermined direction. The illumination light may be delivered to or provided to the light modulator 280 of the projecting system.

Referring further to FIG. 7, the projecting system may include the prism 270, the light modulator 280, and the projection lens unit 290. The projecting system may include the prism 270 as a component thereof. In the embodiment, the prism 270 may be an element of both the illuminating system and the projecting system. Furthermore, the projecting system may modulate the illumination light generated by the illuminating system through the light modulator 280, and emit or radiate the modulated light in a predetermined direction through the prism 270 and the projection lens unit 290.

In addition, in the projection device, the light modulator 280 may reflect the illumination light as patterned light or the like, and the patterned light may pass through the projection lens unit 290 to be output to the outside of the projection device.

In addition, an optical folding member may be present between an output unit of the projection device and an input unit of a light guide or waveguide. The optical folding member may be formed such that an optical path of the patterned light is folded in at least two different directions.

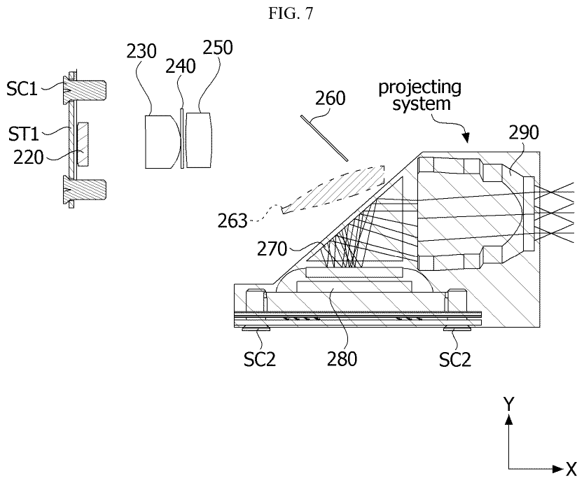

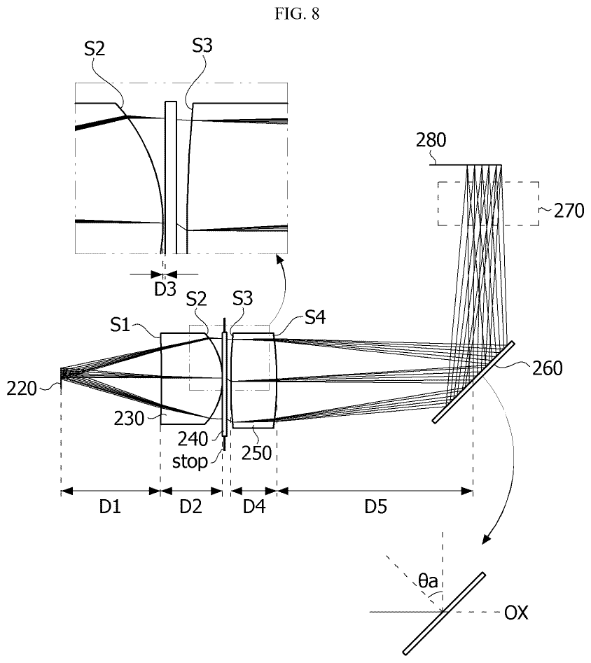

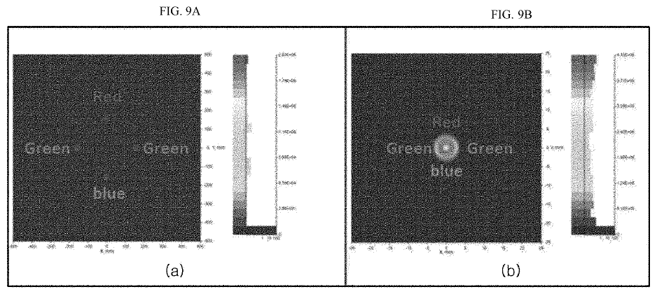

FIG. 8 is an optical system of an illuminating system in a projection device according to a first embodiment of the present invention, FIG. 9 is a diagram for describing effects of the optical system of the illuminating system in the projection device according to the embodiment of the present invention, and FIG. 10 is a diagram showing simulation results of a stop, a diffusion unit, and a light modulator in the projection device according to the embodiment of the present invention.

Referring to FIG. 8, in the projection device according to the first embodiment, an optical system 10 may include, as described above, a light source unit 220 from which light is emitted, an intermediate lens 230, a diffusion unit 240, a rear lens 250, a reflection unit 260, an additional lens 263, and a prism 270, and a light modulator 280, on which light is incident and which is located at the rear end of the prism 270, may correspond to an image in the optical system.

In the present projection device, a position of a stop is located between the light source unit 220 and the light modulator 280, and in particular, the diffusion unit 240 may be disposed at the position of the stop. Accordingly, light or a light bundle emitted from a light source may converge at a position of the diffusion unit 240, and may be easily mixed through the diffusion unit 240 to be provided as white light to the light modulator. As a result, a reduction in size may be easily achieved using a light source composed of a single panel.

In addition, the intermediate lens 230 may include a first surface S1 and a second surface S2. The first surface S1 may be a surface of the intermediate lens 230 facing the light source unit 220. The second surface S2 may be a surface of the intermediate lens 230 facing the light modulator 280.

The rear lens 250 may include a third surface S3 and a fourth surface S4. The third surface S3 may be a surface of the rear lens 250 facing the light source unit 220. The fourth surface S4 may be a surface of the rear lens 250 facing the light modulator 280.

Furthermore, in the projection device according to the embodiment, the contents described in Table 1 (component information) and Table 2 (aspheric surface data) may be applied to each component.

TABLE 1

| Element or | Surface | Y | | | | semi- |
|---|---|---|---|---|---|---|
| surface | type | Radius | Thickness | Index | Abbe | aperture |
| Light source | Sphere | infinity | 4.980 | — | — | 0.500 |
| unit | | | (corresponding | | | |
| | | | to D1) | | | |
| Intermediate | Asphere | −46.444 | 3.000 | 1.497 | 81.55 | 1.584 |
| lens (S1) | | | (corresponding | | | |
| | | | to D2) | | | |
| Intermediate | Asphere | −3.366 | 0.020 | — | — | 2.050 |
| lens (S2) | | | (corresponding | | | |
| | | | to D3) | | | |
| Diffusion | Sphere | infinity | 0.252 | — | — | 2.000 |
| unit | | | | | | |
| (diffuser) | | | | | | |
| Rear lens | Asphere | 22.550 | 2.200 | 1.497 | 81.55 | 2.023 |
| (S3) | | | (corresponding | | | |
| | | | to D4) | | | |
| Rear lens | Asphere | −18.902 | 9.470 | — | — | 2.070 |
| (S4) | | | (corresponding | | | |
| | | | to D5) | | | |
| Reflection | Sphere | infinity | −10.768 | — | — | 2.437 |
| unit (mirror) | | | | | | |
| Light | Sphere | infinity | 0 | — | — | 2.014 |
| modulator | | | | | | |
| (DMD) | | | | | | |

TABLE 2

| | Intermediate | Intermediate | | |
|---|---|---|---|---|
| Parameter Name | lens (S1) | lens (S2) | Rear lens (S3) | Rear lens (S4) |
| Y Radius | −46.4442 | −3.36574 | 22.55015 | −18.9019 |
| Conic constant (K) | 9.916248 | −5.86655 | 0 | −3.71065 |
| 4th order coefficient (A) | −0.0049 | −0.01852 | −8.93E−05 | −0.00077 |
| 6th order coefficient (B) | −0.00031 | 0.003316 | −0.00028 | 9.28E−05 |
| 8th order coefficient (C) | 0.000947 | −0.00105 | 7.69E−05 | −1.17E−05 |
| 10th order coefficient (D) | −0.00093 | 0.000303 | −1.12E−05 | −3.91E−06 |
| 12th order coefficient (E) | 0.000214 | −4.60E−05 | 6.01E−07 | 6.95E−07 |
| 14th order coefficient (F) | 4.54E−05 | −1.70E−06 | 0 | 0 |
| 16th order coefficient (G) | −4.09E−06 | 7.38E−07 | 0 | 0 |
| 18th order coefficient (H) | −9.39E−06 | 1.78E−07 | 0 | 0 |
| 20th order coefficient (J) | 1.66E−06 | −3.43E−08 | 0 | 0 |

Here, a thickness of a left- or light source-side surface of each of the intermediate lens and the rear lens refers to a thickness (related to a refractive index, an Abbe number, and the like) of each of the intermediate lens and the rear lens. A thickness of a right- or light modulator-side surface of each of the intermediate lens and the rear lens refers to a separation distance from a subsequent component. Furthermore, the units for thickness and length may be millimeters (mm). In addition, in each of the diffusion unit and the reflection unit, a thickness refers to a separation distance to a component located at the rear end. In addition, the reason the thickness of the reflection unit is negative (−) is to indicate that the path is changed due to reflection, and a distance from the reflection unit to the light modulator is 10.768 mm. In addition, in the embodiment, the second surface S2 may be disposed apart from the diffusion unit 240. For example, a separation distance D3 between the diffusion unit 240 and the second surface S2 of the intermediate lens 230 may be in a range of 15 μm to 100 μm. Preferably, the separation distance D3 between the diffusion unit 240 and the second surface S2 of the intermediate lens 230 may be in a range of 15 μm to 50 μm. In addition, the separation distance D3 between the second surface S2 and the diffusion unit 240 may be smaller than a separation distance between the diffusion unit 240 and the rear lens 250.

In addition, the first surface S1 may be convex or concave toward the light source unit 220. In the embodiment, the first surface S1 may be concave toward the light source unit 220.

In addition, the second surface S2 may be convex toward the light modulator 280 or the reflection unit 260. With this configuration, red (R), green (G), and blue (B) light may be effectively provided to the reflection unit 260 in a state of being mixed into white light.

In particular, an absolute value of a size of a radius of curvature of the first surface S1 may be greater than an absolute value of a size of a radius of curvature of the second surface S2. Accordingly, the provision of white light to the reflection unit 260 may be improved with improved efficiency.

In addition, the third surface S3 may be convex toward the light source unit 220. In addition, the fourth surface S4 may be convex toward the light modulator or the reflection unit. With this configuration, miniaturization of the reflection unit 260 may be achieved, and distance adjustment may be easily performed in response to illumination performance.

Furthermore, an additional lens may be further disposed between the rear lens 250 and the reflection unit 260.

In addition, an optical axis OX of the light emitted from the light source unit 220 may form an angle θa of 42° to 48° with a reflective surface of the reflection unit 260. For example, the angle may correspond to a reflection angle of the light at the reflection unit 260. With this configuration, the miniaturization may be more easily achieved. In addition, the angle formed between the optical axis OX and the reflective surface of the reflection unit 260 may be adjusted according to a refractive index of the prism 270. The optical axis OX may be parallel to the first direction.

In the embodiment, a distance (D1+D2) from the light source unit 220 to the second surface S2 may be in a range of 5.5 mm to 9 mm. At this time, when the distance (D1+D2) from the light source unit 220 to the second surface S2 is less than 5.5 mm, assembly may be difficult, and, when the distance (D1+D2) from the light source unit 220 to the second surface S2 is greater than 9 mm, miniaturization may become difficult.

A distance (D4+D5) from the third surface S3 to the reflection unit 260 may be in a range of 5 mm to 12 mm. When the distance (D4+D5) from the third surface S3 to the reflection unit 260 is reduced to less than 5 mm, there is a limitation in which assembly is difficult. In addition, when the distance (D4+D5) from the third surface S3 to the reflection unit 260 is 12 mm or more, there is a limitation in achieving miniaturization. Preferably, to achieve miniaturization, the distance (D4+D5) from the third surface S3 to the reflection unit 260 may be 5 mm or more and 10 mm or less.

In addition, a distance D5 from the fourth surface S4 to the reflection unit 260 may be greater than a distance (D1 or D1+D2) from the light source unit 220 to the first surface S1 (or the second surface S2).

Referring to FIG. 9, it can be seen that, when the position of the stop is not located outside or on an outer side of the light source composed of a single panel, the respective lights (R, G, and B) may not converge (see FIG. 9A). In contrast, as shown in FIG. 9B, in the project according to the embodiment, the position of the stop is located on the outer side of the intermediate lens in the light source unit composed of the light source of a single panel, thereby providing a structure in which the light bundle converges or crosses at the stop.

Thus, referring further to FIG. 10, it can be seen from FIG. 10A that the light bundle converges or crosses at the stop, and from FIG. 10B that the light bundle also converges or crosses at the diffusion unit, which is located at the stop.

Furthermore, as shown in FIG. 10C, it can be seen that white light, which is mixed through diffuse reflection in the diffusion unit located at the stop, is provided to the light modulator in a converged form or in a form similar to that at the stop (diffusion unit).

In addition, a diameter of the light converged at the stop or the diffusion unit may be smaller than a diameter of the light converged at the light modulator.

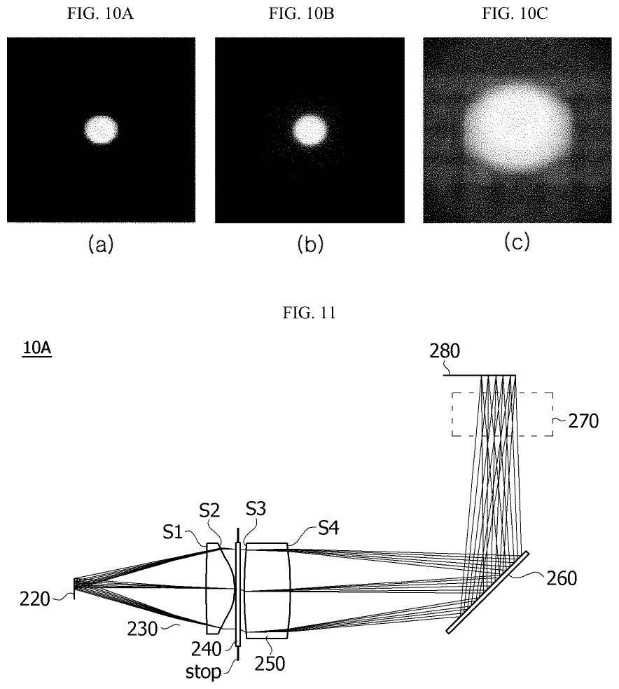

FIG. 11 is an optical system of an illuminating system in a projection device according to a second embodiment of the present invention.

In the projection device according to the second embodiment, an optical system 10A may include, as described above, a light source unit 220 from which light is emitted, an intermediate lens 230, a diffusion unit 240, a rear lens 250, a reflection unit 260, an additional lens 263, and a prism 270, and a light modulator 280, on which light is incident and which is located at the rear end of the prism 270, may correspond to an image in the optical system. In the present projection device, a position of a stop is located between the light source unit 220 and the light modulator 280, and in particular, the diffusion unit 240 may be disposed at the position of the stop. Furthermore, except for the content described later, the above-described content of the projection device may be equally applied.

Furthermore, in the projection device according to the second embodiment, the contents described in Table 3 (component information) and Table 4 (aspheric surface data) may be applied to each component.

TABLE 3

| Element or | Surface | Y | | | | semi- |
|---|---|---|---|---|---|---|
| surface | type | Radius | Thickness | Index | Abbe | aperture |
| Light source | Sphere | infinity | 6.148 | — | — | 0.500 |
| unit | | | | | | |
| Intermediate | Asphere | 28.636 | 1.302 | 1.617 | 63.39 | 1.986 |
| lens (S1) | | | | | | |
| Intermediate | Asphere | −4.924 | 0.020 | — | — | 2.031 |
| lens (S2) | | | | | | |
| Diffusion | Sphere | infinity | 0.252 | — | — | 2.000 |
| unit | | | | | | |
| (diffuser) | | | | | | |
| Rear lens (S3) | Asphere | 22.550 | 2.200 | 1.497 | 81.55 | 2.023 |
| Rear lens (S4) | Asphere | −18.902 | 9.470 | — | — | 2.070 |
| Reflection unit | Sphere | infinity | −10.768 | — | — | 2.437 |
| (mirror) | | | | | | |
| Light modulator | Sphere | infinity | 0 | — | — | 2.014 |
| (DMD) | | | | | | |

TABLE 4

| | Intermediate | Intermediate | | |
|---|---|---|---|---|
| Parameter Name | lens (S1) | lens (S2) | Rear lens (S3) | Rear lens (S4) |
| Y Radius | 28.63596 | −4.92425 | 22.55015 | −18.9019 |
| Conic constant (K) | −4501.02 | −4.13148 | 0 | −3.71065 |
| 4th order coefficient (A) | 0.016361 | −0.00333 | −8.93E−05 | −0.00077 |
| 6th order coefficient (B) | −0.01064 | 0.002564 | −0.00028 | 9.28E−05 |
| 8th order coefficient (C) | 0.004534 | −0.00146 | 7.69E−05 | −1.17E−05 |
| 10th order coefficient (D) | −0.00089 | 0.000402 | −1.12E−05 | −3.91E−06 |
| 12th order coefficient (E) | 5.23E−05 | −2.58E−05 | 6.01E−07 | 6.95E−07 |
| 14th order coefficient (F) | 5.50E−07 | −2.69E−06 | 0 | 0 |
| 16th order coefficient (G) | 8.34E−07 | −3.52E−07 | 0 | 0 |
| 18th order coefficient (H) | 1.51E−07 | 8.81E−09 | 0 | 0 |
| 20th order coefficient (J) | −5.00E−08 | 2.01E−08 | 0 | 0 |

Here, a thickness of a left- or light source-side surface of each of the intermediate lens and the rear lens refers to a thickness (related to a refractive index, an Abbe number, and the like) of each of the intermediate lens and the rear lens. A thickness of a right- or light modulator-side surface of each of the intermediate lens and the rear lens refers to a separation distance from a subsequent component. Furthermore, the units for thickness and length may be millimeters (mm). In addition, in each of the diffusion unit and the reflection unit, a thickness refers to a separation distance to a component located at the rear end. In addition, the reason the thickness of the reflection unit is negative (−) is to indicate that the path is changed due to reflection, and a distance from the reflection unit to the light modulator is 10.768 mm. In the embodiment, a first surface S1 may be convex toward the light source unit 220. Furthermore, a distance from the light source unit 220 to the first surface S1 may be at least four times greater than a thickness of the intermediate lens 230. Furthermore, the reference in Table 1 may be applied. With this configuration, a distance from the light source unit 220 to a second surface S2 may be adjustable. For example, the distance from the light source unit 220 to the second surface S2 may be reduced, thereby shortening a length of the projection device in the first direction.

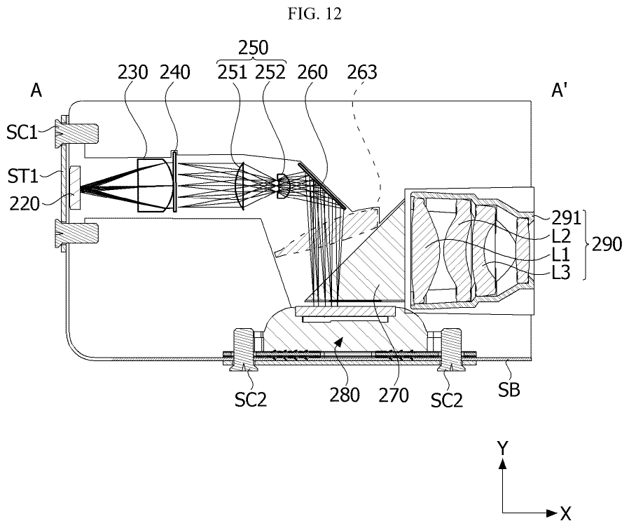

FIG. 12 is another example of FIG. 5.

Referring to FIG. 12, in another example, a projection device 200 according to another example may include a housing 210, a light source unit 220, an intermediate lens 230, a diffusion unit 240, a rear lens group 250, a reflection unit 260, an additional lens 263, a prism 270, a light modulator 280, a projection lens unit 290, and a blocking member TP.

The housing 210 may have a space or a housing recess in which each component of the projection device 200 is accommodated or disposed. The housing 210 may be located on an outer side of the projection device 200. For example, the light source unit 220, the intermediate lens 230, the diffusion unit 240, the rear lens group 250, the reflection unit 260, the additional lens 263, the prism 270, the light modulator 280, and the projection lens unit 290 may be disposed in the housing 210. The following description may be applied to contents described later.

In the present example, a position of a stop may be located between the intermediate lens 230 and the rear lens group 250. Accordingly, an optical stop, or the stop, may be an area in which light or a light bundle converges (or intersects). Accordingly, the position of the stop may correspond to a point at which light of different wavelengths intersects. For example, the stop may correspond to a position of an aperture. The stop may be an aperture stop or a field stop.

In addition, the rear lens group 250 may be located at the rear end of the diffusion unit 240. Accordingly, the diffusion unit 240 may be located between the rear lens group 250 and the intermediate lens 230.

Furthermore, the rear lens group 250 may be located between the diffusion unit 240 and the light modulator 280. In addition, the rear lens group 250 may be located between the diffusion unit 240 (or the light source unit or the intermediate lens) and the prism (or the reflection unit).

The rear lens group 250 may include a first rear lens 251 and a second rear lens 252. The second rear lens 252 may be located at the rear end of the first rear lens 251. In addition, the first rear lens 251 may be disposed between the diffusion unit 240 and the light modulator (or the reflection unit). In addition, the second rear lens 252 may be located between the first rear lens 251 and the light modulator (or the reflection unit).

The intermediate lens 230 and the rear lens group 250 may each include a relay lens and/or a collimator lens. For example, the intermediate lens 230 may be a collimator lens. In addition, the rear lens group 250 may be a relay lens.

The reflection unit 260 may be located at the rear end of the rear lens group 250. The reflection unit 260 may be located on the side of the rear lens group 250 in the first direction (X-axis direction). The reflection unit 260 may be disposed apart from the rear lens group 250 in the first direction. The reflection unit 260 may be located between the rear lens group 250 and the prism 270 (or light modulator).

In addition, the reflection unit 260 may be inclined at a predetermined angle with respect to the rear lens group 250. The reflection unit 260 may reflect light transmitted through the rear lens group 250. For example, light that has passed through the rear lens 250 may be reflected by the reflection unit 260, change its path toward the projection lens unit, and then be reflected toward the prism or light modulator therebelow.

The reflection unit 260 may be inclined at a predetermined angle with respect to the rear lens group 250, the first direction, or the like. With this configuration, a length of the projection device according to the embodiment in the second direction may be minimized.

The prism 270 may be located at the rear end of the rear lens group 250. Further, a prism 270 may be disposed at the rear end of the additional lens 263. In addition, the prism 270 may be located between the rear lens group 250 and the light modulator 280.

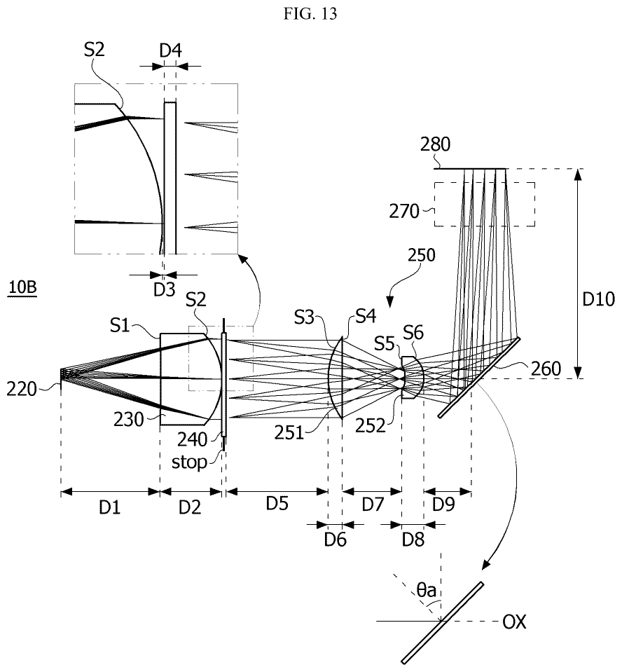

FIG. 13 is an optical system for an illuminating system in a projection device according to a third embodiment of the present invention.

Referring to FIG. 13, in the projection device according to one embodiment, an optical system 10B may include, as described above, a light source unit 220 from which light is emitted, an intermediate lens 230, a diffusion unit 240, a rear lens group 250, a reflection unit 260, an additional lens 263, and a prism 270, and a light modulator 280, on which light is incident and which is located at the rear end of the prism 270, may correspond to an image in the optical system.

In the present projection device, a position of a stop is located between the light source unit 220 and the light modulator 280, and in particular, the diffusion unit 240 may be disposed at the position of the stop. Accordingly, light or a light bundle emitted from a light source may converge at a position of the diffusion unit 240, and may be easily mixed through the diffusion unit 240 to be provided as white light to the light modulator. As a result, a reduction in size may be easily achieved using a light source composed of a single panel. In addition, due to the diffusion unit 240, a propagation angle of the light bundle that has passed through the intermediate lens may be newly designed. That is, the diffusion unit 240 may serve as a virtual surface.

In addition, the intermediate lens 230 may include a light source-side surface S1 of the intermediate lens and a reflection unit-side surface S2 of the intermediate lens. The light source-side surface S1 of the intermediate lens may refer to a surface of the intermediate lens 230 facing the light source unit 220. The reflection unit-side surface S2 of the intermediate lens may refer to a surface of the intermediate lens 230 facing the light modulator 280. Furthermore, the light source-side surface to be described later corresponds to a surface of the corresponding component that faces the light source unit. The reflection unit-side surface corresponds to a surface of the corresponding component that faces the reflection unit.

In the rear lens group 250, a first rear lens 251 may include a light source-side surface S3 and a reflection unit-side surface S4. The light source-side surface S3 of the first rear lens may refer to a surface of the rear lens group 250 facing the light source unit 220. The reflection unit-side surface S4 of the first rear lens may refer to a surface of the rear lens group 250 facing the light modulator 280.

In addition, in the rear lens group 250, a second rear lens 252 may include a light source-side surface S5 and a reflection unit-side surface S6. The light source-side surface S5 of the first rear lens may refer to a surface of the rear lens group 250 facing the light source unit 220. The reflection unit-side surface S6 of the first rear lens may refer to a surface of the rear lens group 250 facing the light modulator 280.

In addition, in the embodiment, an effective diameter of the first rear lens 251 may be greater than an effective diameter of the second rear lens 252. At least one of effective diameters of the light source-side surface S3 and the reflection unit-side surface S4 of the first rear lens 251 may be greater than at least one of effective diameters of the light source-side surface S5 and the reflection unit-side surface S6 of the second rear lens 252. For example, an effective diameter of the reflection unit-side surface S2 of the first rear lens 251 may be greater than that of the light source-side surface S3 of the second rear lens 252.

With this configuration, effective diameter control may be performed through the first rear lens 251, thereby allowing the effective diameter of the second rear lens 252 to be reduced, which can provide the effect of improving aberration performance.

Furthermore, in the first rear lens 251, a ratio of the effective diameter of the reflection unit-side surface S2 to the effective diameter of the light source-side surface S3 of the second rear lens 252 may be in a range of 1:3.4 to 1:4.1. When the ratio is less than 1:3.4, aberration performance may deteriorate, and when the ratio is greater than 1:4.1, there is a limitation in manufacturing the second rear lens.

Furthermore, in the projection device according to the embodiment, the contents described in Table 5 (component information) and Table 6 (aspheric surface data) may be applied to each component.

TABLE 5

| Element or | Surface | | | | | semi- |
|---|---|---|---|---|---|---|
| surface | type | Y Radius | Thickness | Index | Abbe | aperture |
| Light source | Sphere | infinity | 4.980 | — | — | 0.500 |
| unit | | | | | | |
| Intermediate | Asphere | −46.444 | 3.000 | 1.497 | 81.55 | 1.584 |
| lens (S1) | | | | | | |
| Intermediate | Asphere | −3.366 | 0.020 | — | — | 2.050 |
| lens (S2) | | | | | | |
| Diffusion | Sphere | infinity | (0.4)TBD | — | — | 2.000 |
| unit | | | | | | |
| (diffuser) | | | | | | |
| Air | Asphere | infinity | 5.000 | — | — | 2 |
| First rear | Asphere | 3.403 | 1.093 | 1.69678 | 55.46 | 2.114 |
| lens (S3) | | | | | | |
| First rear | Asphere | −31.743 | 2.741 | — | — | 2.030 |
| lens (S4) | | | | | | |
| Air | Sphere | infinity | 0.207 | — | — | 0.560 |
| Second rear | Asphere | −1.544 | 0.959 | 1.6385 | 55.17 | 0.593 |
| lens (S5) | | | | | | |
| Second rear | Asphere | −1.390 | 1.700 | — | — | 0.931 |
| lens (S6) | | | | | | |
| Reflection | Sphere | infinity | 0.020 | — | — | 1.607 |
| unit (mirror) | | | | | | |
| Air | Sphere | infinity | 0.880 | — | — | 1.594 |
| Air | Sphere | infinity | 4.999 | — | — | 1.101 |
| Light | Sphere | infinity | 0.000 | — | — | 1.992 |
| modulator | | | | | | |
| (DMD) | | | | | | |

TABLE 6

| Parameter | Intermediate | Intermediate | First rear | First rear | Second rear | Second rear |
|---|---|---|---|---|---|---|
| Name | lens (S1) | lens (S2) | lens (S3) | lens (S4) | lens (S5) | lens (S6) |
| Y Radius | −46.4441665 | −3.36574302 | 3.156033619 | 116.6128589 | −1.62065146 | −1.45745607 |
| Conic | 9.916248105 | −5.86655125 | −0.32152471 | 2440.381269 | 0 | 0.029118354 |
| constant (K) | | | | | | |
| 4th order | −0.00489658 | −0.01852371 | −0.00135862 | −0.00032918 | −4.25E−02 | −0.01058586 |
| coefficient (A) | | | | | | |
| 6th order | −0.00031294 | 0.003316493 | −9.41E−05 | −6.49E−05 | −0.33969245 | −1.20E−02 |
| coefficient (B) | | | | | | |
| 8th order | 0.000947377 | −0.0010524 | −1.53E−06 | −1.11E−05 | 5.58E−01 | 3.55E−03 |
| coefficient (C) | | | | | | |
| 10th order | −0.00092766 | 0.000302912 | 7.34E−07 | −5.30E−07 | 1.45E−01 | 7.92E−03 |
| coefficient (D) | | | | | | |
| 12th order | 0.000213995 | −4.60E−05 | −9.16E−08 | 1.25E−07 | −2.39E+00 | −1.73E−02 |
| coefficient (E) | | | | | | |
| 14th order | 4.54E−05 | −1.70E−06 | 0.00E+00 | 0.00E+00 | 0 | 0 |
| coefficient (F) | | | | | | |
| 16th order | −4.09E−06 | 7.38E−07 | 0.00E+00 | 0.00E+00 | 0 | 0 |
| coefficient (G) | | | | | | |
| 18th order | −9.39E−06 | 1.78E−07 | 0.00E+00 | 0.00E+00 | 0 | 0 |
| coefficient (H) | | | | | | |
| 20th order | 1.66E−06 | −3.43E−08 | 0.00E+00 | 0.00E+00 | 0 | 0 |
| coefficient (J) | | | | | | |

Here, a thickness of a left- or light source-side surface of each of the intermediate lens and the first rear lens refers to a thickness (related to a refractive index, an Abbe number, and the like) of each of the intermediate lens and the first rear lens (or the second rear lens). A thickness of a right- or light modulator-side surface of each of the intermediate lens and the first rear lens refers to a separation distance from a subsequent component. In addition, the term “Air” refers to an additional separation distance between two adjacent elements. Accordingly, a separation distance between the first rear lens and the second rear lens may be 2.948 mm (2.741+0.207). Furthermore, the units for thickness and length may be millimeters (mm). In addition, in each of the diffusion unit and the reflection unit, the thickness refers to a separation distance to a component located at the rear end. In the embodiment, a distance (D1+D2) from the light source unit 220 to the reflection unit-side surface S2 of the intermediate lens may be in a range of 5.5 mm to 9 mm. In this case, when the distance (D1+D2) from the light source unit 220 to the reflection unit-side surface S2 of the intermediate lens is less than 5.5 mm, assembly may be difficult, and when the distance (D1+D2) from the light source unit 220 to the reflection unit-side surface S2 of the intermediate lens is greater than 9 mm, miniaturization may become difficult. A thickness D2 of the intermediate lens 230 may be smaller than a distance D1 from the light source unit 220 to the light source-side surface S1 of the intermediate lens. In addition, the thickness D2 of the intermediate lens 230 may be variously changed. For example, the thickness D2 of the intermediate lens 230 may be smaller than a thickness D6 of the first rear lens or a thickness D8 of the second rear lens.

In addition, the reflection unit-side surface S2 of the intermediate lens 230 may be disposed apart from the diffusion unit 240. For example, a separation distance D3 between the diffusion unit 240 and the reflection unit-side surface S2 of the intermediate lens of the intermediate lens 230 may be in a range of 15 μm to 100 μm. Preferably, the separation distance D3 between the diffusion unit 240 and the reflection unit-side surface S2 of the intermediate lens of the intermediate lens 230 may be in a range of 15 μm to 50 μm.

In addition, the separation distance D3 between the reflection unit-side surface S2 of the intermediate lens 230 and the diffusion unit 240 may be smaller than a separation distance D5 between the diffusion unit 240 and the rear lens group 250.

In addition, a thickness D4 of the diffusion unit 240 may be smaller than the separation distance D3 between the diffusion unit 240 and the reflection unit-side surface S2 of the intermediate lens of the intermediate lens 230. However, depending on the thickness D4 of the diffusion unit 240, the thickness D4 may be greater than or equal to the separation distance D3 between the diffusion unit 240 and the reflection unit-side surface S2 of the intermediate lens of the intermediate lens 230.

The separation distance D5 from the diffusion unit 240 to the light source-side surface S3 of the first rear lens 251 may be in a range of 1 mm to 5 mm. When the separation distance D5 from the diffusion unit 240 to the light source-side surface S3 of the first rear lens 251 is less than 1 mm, there is a limitation in which assembly is difficult. When the separation distance D5 from the diffusion unit 240 to the light source-side surface S3 of the first rear lens 251 is greater than 5 mm, miniaturization may become difficult.

In addition, the separation distance D5 between the diffusion unit 240 and the first rear lens 251 may be greater than at least one of the separation distance D3 between the intermediate lens 230 and the diffusion unit 240, a separation distance D7 between the first rear lens 251 and the second rear lens 252, and a separation distance D9 between the second rear lens 252 and the reflection unit 260. Accordingly, efficiency improvement may be achieved by focusing the light bundle at the diffusion unit.

The thickness D6 of the first rear lens 251 may be greater than the thickness D8 of the second rear lens 252. The thickness D6 of the first rear lens 251 and the thickness D8 of the second rear lens 252 may each be greater or smaller than the thickness D2 of the intermediate lens 230. In the embodiment, the thickness D6 of the first rear lens 251 and the thickness D8 of the second rear lens 252 may each be smaller than the thickness D2 of the intermediate lens 230.

A distance D10 from the reflection unit 260 to the light modulator 280 may be greater than the separation distance D5 between the diffusion unit 240 and the rear lens group 250. Furthermore, the distance D10 from the reflection unit 260 to the light modulator 280 may be greater than the thickness D2 of the intermediate lens 230, the thickness D6 of the first rear lens 251, or the thickness D8 of the second rear lens 252.

In addition, a distance (D6+D7+D8+D9) from the light source-side surface S3 of the first rear lens to the reflection unit 260 may be in a range of 5 mm to 12 mm. When the distance (D6+D7+D8+D9) from the light source-side surface S3 of the first rear lens to the reflection unit 260 is reduced to less than 5 mm, there is a limitation in which assembly is difficult. In addition, when the distance (D6+D7+D8+D9) from the light source-side surface S3 of the first rear lens to the reflection unit 260 is 12 mm or more, there is a limitation in achieving miniaturization. Preferably, to achieve miniaturization, the distance (D6+D7+D8+D9) from the light source-side surface S3 of the first rear lens to the reflection unit 260 may be 5 mm or more and 10 mm or less.

Furthermore, a separation distance (D5+D6+D7+D8+D9) from the diffusion unit 240 to the reflection unit 260 may be in a range of 11.7 mm to 12.3 mm. For example, when the separation distance (D5+D6+D7+D8+D9) from the diffusion unit 240 to the reflection unit 260 is less than 11.7 mm, difficulties may arise in designing the focusing and the lens shape. In addition, when the separation distance (D5+D6+D7+D8+D9) from the diffusion unit 240 to the reflection unit 260 is greater than 12.3 mm, miniaturization may become difficult.

In addition, the light source-side surface S1 of the intermediate lens may be convex or concave toward the light source unit 220. In the embodiment, the light source-side surface S1 of the intermediate lens may be concave toward the light source unit 220.

Further, the reflection unit-side surface S2 of the intermediate lens may be convex toward the light modulator 280 or the reflection unit 260. In other words, the reflection unit-side surface S2 of the intermediate lens may be concave toward the light source unit 220. With this configuration, red (R), green (G), and blue (B) light may be effectively provided to the reflection unit 260 in a state of being mixed into white light.

In particular, an absolute value of a size of a radius of curvature of the light source-side surface S1 of the intermediate lens may be greater than an absolute value of a size of a radius of curvature of the reflection unit-side surface S2 of the intermediate lens. Accordingly, the provision of white light to the reflection unit 260 may be provided with improved efficiency.

In addition, the light source-side surface S3 of the first rear lens may be convex toward the light source unit 220. In addition, the reflection unit-side surface S4 of the first rear lens may be convex toward the light modulator or the reflection unit. With this configuration, miniaturization of the reflection unit 260 may be achieved, and distance adjustment may be easily performed in response to illumination performance.

The light source-side surface S5 of the second rear lens may be convex toward the reflection unit. In addition, the reflection unit-side surface of the second rear lens may be convex toward the reflection unit.

In addition, an optical axis OX of the light emitted from the light source unit 220 may form an angle θa of 42° to 48° with a reflective surface of the reflection unit 260. For example, the angle may correspond to a reflection angle of the light at the reflection unit 260. With this configuration, the miniaturization may be more easily achieved. In addition, the angle formed between the optical axis OX and the reflective surface of the reflection unit 260 may be adjusted according to a refractive index of the prism 270. The optical axis OX may be parallel to the first direction.

In addition, a size of the diffusion unit 240 may be smaller than at least one of maximum effective diameters of the intermediate lens 230 and the first rear lens 251. When the diffusion unit 240 is a micro lens array, the entire active area (AA) may correspond to the size of the diffusion unit 240. With this configuration, mixing of the light bundle by the diffusion unit 240 at the stop may be easily performed, and the efficiency of white light emitted from the diffusion unit 240 may be increased.

Further, the effective diameter of the first rear lens 251 may be larger than an effective diameter of the reflection unit 260. Accordingly, a miniaturized optical system or projection device may be provided.

Furthermore, the refractive index of the intermediate lens 230 may be smaller than the refractive index of each of the first rear lens 251 and the second rear lens 252.

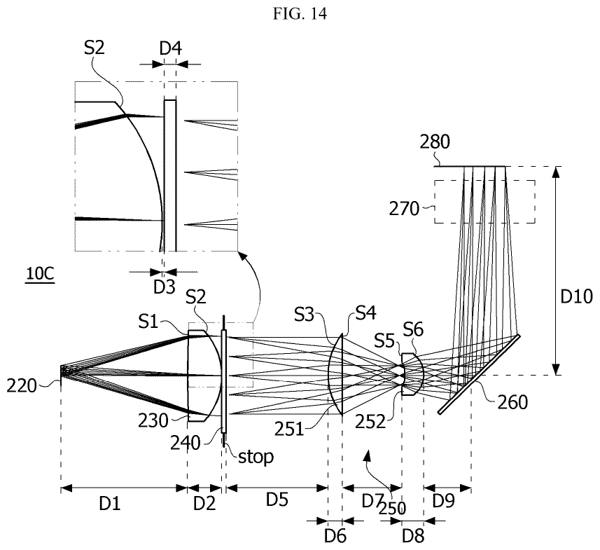

FIG. 14 is an optical system for an illuminating system in a projection device according to a fourth embodiment of the present invention.

In the projection device according to the fourth embodiment, an optical system 10C may include, as described above, a light source unit 220 from which light is emitted, an intermediate lens 230, a diffusion unit 240, a rear lens group 250, a reflection unit 260, an additional lens 263, and a prism 270, and a light modulator 280, on which light is incident and which is located at the rear end of the prism 270, may correspond to an image in the optical system. In the present projection device, a position of a stop is located between the light source unit 220 and the light modulator 280, and in particular, the diffusion unit 240 may be disposed at the position of the stop. Furthermore, except for the content described later, the above-described content of the projection device may be equally applied.

Furthermore, in the projection device according to another embodiment, the contents described in Table 7 (component information) and Table 8 (aspheric surface data) may be applied to each component.

TABLE 7

| Element or | Surface | | | | | semi- |
|---|---|---|---|---|---|---|
| surface | type | Y Radius | Thickness | Index | Abbe | aperture |
| Light source | Sphere | infinity | 4.980 | — | — | 0.500 |
| unit | | | | | | |
| Intermediate | Asphere | −46.444 | 3.000 | 1.497 | 81.55 | 1.584 |
| lens (S1) | | | | | | |
| Intermediate | Asphere | −3.366 | 0.020 | — | — | 2.050 |
| lens (S2) | | | | | | |
| Diffusion | Sphere | infinity | (0.4)TBD | — | — | 2.000 |
| unit | | | | | | |
| (diffuser) | | | | | | |
| Air | Asphere | infinity | 5.000 | — | — | 2 |
| First rear | Asphere | 3.403 | 1.093 | 1.69678 | 55.46 | 2.114 |
| lens (S3) | | | | | | |
| First rear | Asphere | −31.743 | 2.741 | — | — | 2.030 |
| lens (S4) | | | | | | |
| Air | Sphere | infinity | 0.207 | — | — | 0.560 |
| Second rear | Asphere | −1.544 | 0.959 | 1.6385 | 55.17 | 0.593 |
| lens (S5) | | | | | | |
| Second rear | Asphere | −1.390 | 1.700 | — | — | 0.931 |
| lens (S6) | | | | | | |
| Reflection | Sphere | infinity | 0.020 | — | — | 1.607 |
| unit (mirror) | | | | | | |
| Air | Sphere | infinity | 0.880 | — | — | 1.594 |
| Air | Sphere | infinity | 4.999 | — | — | 1.101 |
| Light | Sphere | infinity | 0.000 | — | — | 1.992 |
| modulator | | | | | | |
| (DMD) | | | | | | |

TABLE 8

| Parameter | Intermediate | Intermediate | First rear | First rear | Second rear | Second rear |
|---|---|---|---|---|---|---|
| Name | lens (S1) | lens (S2) | lens (S3) | lens (S4) | lens (S5) | lens (S6) |
| Y Radius | −46.4441665 | −3.36574302 | 3.156033619 | 116.6128589 | −1.62065146 | −1.45745607 |
| Conic | 9.916248105 | −5.86655125 | −0.32152471 | 2440.381269 | 0 | 0.029118354 |
| constant (K) | | | | | | |
| 4th order | −0.00489658 | −0.01852371 | −0.00135862 | −0.00032918 | −4.25E−02 | −0.01058586 |
| coefficient (A) | | | | | | |
| 6th order | −0.00031294 | 0.003316493 | −9.41E−05 | −6.49E−05 | −0.33969245 | −1.20E−02 |
| coefficient (B) | | | | | | |
| 8th order | 0.000947377 | −0.0010524 | −1.53E−06 | −1.11E−05 | 5.58E−01 | 3.55E−03 |
| coefficient (C) | | | | | | |
| 10th order | −0.00092766 | 0.000302912 | 7.34E−07 | −5.30E−07 | 1.45E−01 | 7.92E−03 |
| coefficient (D) | | | | | | |
| 12th order | 0.000213995 | −4.60E−05 | −9.16E−08 | 1.25E−07 | −2.39E+00 | −1.73E−02 |
| coefficient (E) | | | | | | |
| 14th order | 4.54E−05 | −1.70E−06 | 0.00E+00 | 0.00E+00 | 0 | 0 |
| coefficient (F) | | | | | | |
| 16th order | −4.09E−06 | 7.38E−07 | 0.00E+00 | 0.00E+00 | 0 | 0 |
| coefficient (G) | | | | | | |
| 18th order | −9.39E−06 | 1.78E−07 | 0.00E+00 | 0.00E+00 | 0 | 0 |
| coefficient (H) | | | | | | |
| 20th order | 1.66E−06 | −3.43E−08 | 0.00E+00 | 0.00E+00 | 0 | 0 |
| coefficient (J) | | | | | | |

Here, a thickness of a left- or light source-side surface of each of the intermediate lens and a first rear lens refers to a thickness (related to a refractive index, an Abbe number, and the like) of each of the intermediate lens and the first rear lens (or the second rear lens). A thickness of a right- or light modulator-side surface of each of the intermediate lens and the first rear lens refers to a separation distance from a subsequent component. In addition, the term “Air” refers to an additional separation distance between two adjacent elements. Accordingly, a separation distance between the first rear lens and the second rear lens may be 2.948 mm (2.741+0.207). Furthermore, the units for thickness and length may be millimeters (mm). In addition, in each of the diffusion unit and the reflection unit, a thickness refers to a separation distance to a component located at the rear end. In the embodiment, the light source-side surface S1 of the intermediate lens may be convex toward the light source unit 220. In addition, an absolute value of a size of a radius of curvature of the light source-side surface S1 of the intermediate lens may be greater than an absolute value of a size of a radius of curvature of the reflection unit-side surface S2 of the intermediate lens. Accordingly, white light may be provided to the reflection unit 260 with improved efficiency. A thickness D2 of the intermediate lens 230 may be smaller than each of a separation distance D7 between a first rear lens 251 and a second rear lens 252 and a separation distance D9 between the second rear lens 252 and the reflection unit 260.

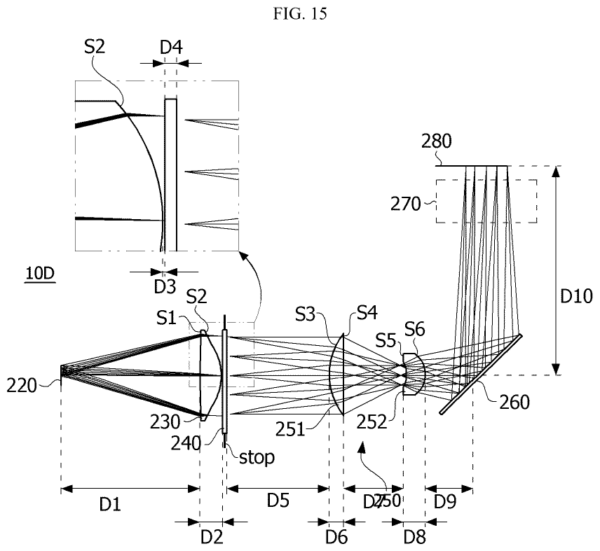

FIG. 15 is an optical system for an illuminating system in a projection device according to a fifth embodiment of the present invention.

In the projection device according to the fifth embodiment, an optical system 10D may include, as described above, a light source unit 220 from which light is emitted, an intermediate lens 230, a diffusion unit 240, a rear lens group 250, a reflection unit 260, an additional lens 263, and a prism 270, and a light modulator 280, on which light is incident and which is located at the rear end of the prism 270, may correspond to an image in the optical system. In the present projection device, a position of a stop is located between the light source unit 220 and the light modulator 280, and in particular, the diffusion unit 240 may be disposed at the position of the stop. Furthermore, except for the content described later, the above-described content of the projection device may be equally applied.

Furthermore, in the projection device according to another embodiment, the contents described in Table 9 (component information) and Table 10 (aspheric surface data) may be applied to each component.

TABLE 9

| Element or | Surface | | | | | semi- |
|---|---|---|---|---|---|---|
| surface | type | Y Radius | Thickness | Index | Abbe | aperture |
| Light source | Sphere | infinity | 4.980 | — | — | 0.500 |
| unit | | | | | | |
| Intermediate | Asphere | −46.444 | 3.000 | 1.497 | 81.55 | 1.584 |
| lens (S1) | | | | | | |
| Intermediate | Asphere | −3.366 | 0.020 | — | — | 2.050 |
| lens (S2) | | | | | | |
| Diffusion | Sphere | infinity | (0.4)TBD | — | — | 2.000 |
| unit | | | | | | |
| (diffuser) | | | | | | |
| Air | Asphere | infinity | 5.000 | — | — | 2 |
| First rear | Asphere | 3.403 | 1.093 | 1.69678 | 55.46 | 2.114 |
| lens (S3) | | | | | | |
| First rear | Asphere | −31.743 | 2.741 | — | — | 2.030 |
| lens (S4) | | | | | | |
| Air | Sphere | infinity | 0.207 | — | — | 0.560 |
| Second rear | Asphere | −1.544 | 0.959 | 1.6385 | 55.17 | 0.593 |
| lens (S5) | | | | | | |
| Second rear | Asphere | −1.390 | 1.700 | — | — | 0.931 |
| lens (S6) | | | | | | |
| Reflection | Sphere | infinity | 0.020 | — | — | 1.607 |
| unit (mirror) | | | | | | |
| Air | Sphere | infinity | 0.880 | — | — | 1.594 |
| Air | Sphere | infinity | 4.999 | — | — | 1.101 |
| Light | Sphere | infinity | 0.000 | — | — | 1.992 |
| modulator | | | | | | |
| (DMD) | | | | | | |

TABLE 10

| Parameter | Intermediate | Intermediate | First rear | First rear | Second rear | Second rear |
|---|---|---|---|---|---|---|
| Name | lens (S1) | lens (S2) | lens (S3) | lens (S4) | lens (S5) | lens (S6) |
| Y Radius | −46.4441665 | −3.36574302 | 3.156033619 | 116.6128589 | −1.62065146 | −1.45745607 |
| Conic | 9.916248105 | −5.86655125 | −0.32152471 | 2440.381269 | 0 | 0.029118354 |
| constant (K) | | | | | | |
| 4th order | −0.00489658 | −0.01852371 | −0.00135862 | −0.00032918 | −4.25E−02 | −0.01058586 |
| coefficient (A) | | | | | | |
| 6th order | −0.00031294 | 0.003316493 | −9.41E−05 | −6.49E−05 | −0.33969245 | −1.20E−02 |
| coefficient (B) | | | | | | |
| 8th order | 0.000947377 | −0.0010524 | −1.53E−06 | −1.11E−05 | 5.58E−01 | 3.55E−03 |
| coefficient (C) | | | | | | |
| 10th order | −0.00092766 | 0.000302912 | 7.34E−07 | −5.30E−07 | 1.45E−01 | 7.92E−03 |
| coefficient (D) | | | | | | |
| 12th order | 0.000213995 | −4.60E−05 | −9.16E−08 | 1.25E−07 | −2.39E+00 | −1.73E−02 |
| coefficient (E) | | | | | | |
| 14th order | 4.54E−05 | −1.70E−06 | 0.00E+00 | 0.00E+00 | 0 | 0 |
| coefficient (F) | | | | | | |
| 16th order | −4.09E−06 | 7.38E−07 | 0.00E+00 | 0.00E+00 | 0 | 0 |
| coefficient (G) | | | | | | |
| 18th order | −9.39E−06 | 1.78E−07 | 0.00E+00 | 0.00E+00 | 0 | 0 |
| coefficient (H) | | | | | | |
| 20th order | 1.66E−06 | −3.43E−08 | 0.00E+00 | 0.00E+00 | 0 | 0 |
| coefficient (J) | | | | | | |

Here, a thickness of a left- or light source-side surface of each of the intermediate lens and a first rear lens refers to a thickness (related to a refractive index, an Abbe number, and the like) of each of the intermediate lens and the first rear lens (or the second rear lens). A thickness of a right- or light modulator-side surface of each of the intermediate lens and the first rear lens refers to a separation distance from a subsequent component. In addition, the term “Air” refers to an additional separation distance between two adjacent elements. Accordingly, a separation distance between the first rear lens and the second rear lens may be 2.948 mm (2.741+0.207). Furthermore, the units for thickness and length may be millimeters (mm). In addition, in each of the diffusion unit and the reflection unit, the thickness refers to a separation distance to a component located at the rear end. In the embodiment, a light source-side surface S1 of the intermediate lens may be convex toward the light source unit 220. In addition, an absolute value of a size of a radius of curvature of the light source-side surface S1 of the intermediate lens may be greater than an absolute value of a size of a radius of curvature of a reflection unit-side surface S2 of the intermediate lens. For example, the light source-side surface S1 of the intermediate lens may be a flat planar surface. Accordingly, the light source-side surface S1 of the intermediate lens may have an infinite radius of curvature. As a result, white light may be provided to the reflection unit 260 with improved efficiency. In addition, as the absolute value of the size of the radius of curvature of the light source-side surface S1 of the intermediate lens increases, the absolute value of the size of the radius of curvature of the reflection unit-side surface S2 of the intermediate lens may decrease.

In addition, a thickness D2 of the intermediate lens 230 may be smaller than a separation distance D7 between a first rear lens 251 and a second rear lens 252 and a separation distance D9 between the second rear lens 252 and the reflection unit 260.

In addition, the thickness D2 of the intermediate lens 230 may be smaller than a thickness D6 of the first rear lens or a thickness D8 of the second rear lens.

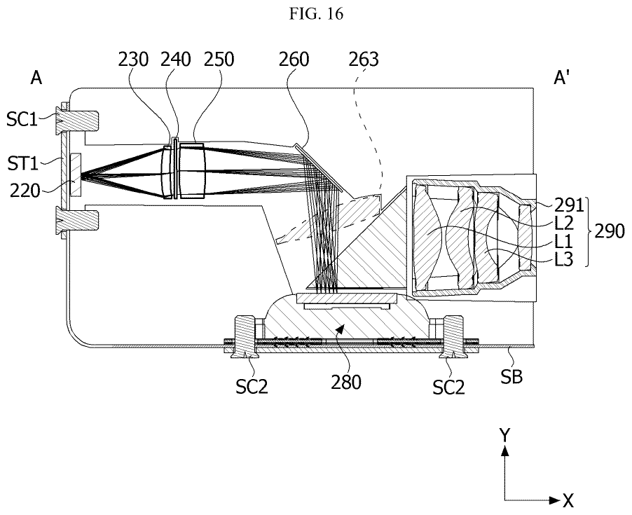

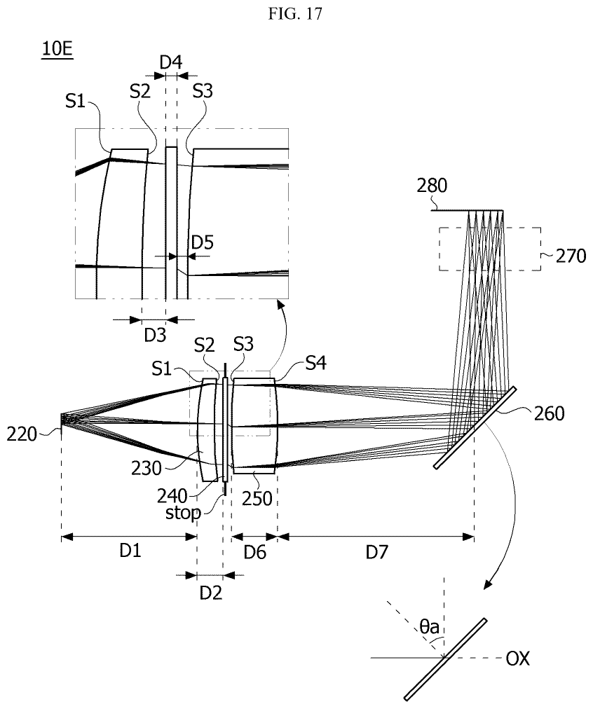

FIG. 16 is still another example of FIG. 5, and FIG. 17 is an optical system for an illuminating system in a projection device according to a sixth embodiment of the present invention.

Referring to FIGS. 16 and 17, in the projection device according to the sixth embodiment, an optical system 10E for the illuminating system may include, as described above, a light source unit 220 from which light is emitted, an intermediate lens 230, a diffusion unit 240, a rear lens 250, a reflection unit 260, an additional lens 263, and a prism 270, and a light modulator 280, on which light is incident and which is located at the rear end of the prism 270, may correspond to an image in the optical system for an illuminating system. Furthermore, in the optical system for the illuminating system, an object may correspond to the light source unit.

In the present projection device, a position of a stop is located between the light source unit 220 and the light modulator 280, and in particular, the diffusion unit 240 may be disposed at the position of the stop. The diffusion unit 240 may also be located between the light source unit 220 and the light modulator 280. In particular, an optical stop is located between the intermediate lens 230 and the rear lens 250, and the diffusion unit 240 may also be located between the intermediate lens 230 and the rear lens 250.

As such, by disposing the diffusion unit 240 at the optical stop, light or a light bundle emitted from a light source may converge at the position of the diffusion unit 240, and may be easily mixed through the diffusion unit 240 to be provided as white light to the light modulator. As a result, a reduction in size may be easily achieved using a light source composed of a single panel. In addition, due to the diffusion unit 240, a propagation angle of the light bundle that has passed through the intermediate lens may be newly designed. That is, the diffusion unit 240 may serve as a virtual surface.

In addition, the intermediate lens 230 may include a light source-side surface S1 of the intermediate lens and a reflection unit-side surface S2 of the intermediate lens. The light source-side surface S1 of the intermediate lens may refer to a surface of the intermediate lens 230 facing the light source unit 220. The reflection unit-side surface S2 of the intermediate lens may refer to a surface of the intermediate lens 230 facing the light modulator 280.

The rear lens 250 may include a light source-side surface S3 of the rear lens and a reflection unit-side surface S4 of the rear lens. The light source-side surface S3 of the rear lens may refer to a surface of the rear lens 250 facing the light source unit 220. The reflection unit-side surface S4 of the rear lens may refer to a surface of the rear lens 250 facing the light modulator 280.

Furthermore, in the projection device according to the embodiment, the contents described in Table 11 (component information) and Table 12 (aspheric surface data) may be applied to each component.

TABLE 11

| Element or | Surface | | | | | semi- |
|---|---|---|---|---|---|---|
| surface | type | Y Radius | Thickness | Index | Abbe | aperture |
| Light source | Sphere | infinity | 6.415 | — | — | 0.500 |
| unit | | | | | | |
| Intermediate | Asphere | 3.864 | 0.500 | 1.6907 | 23 | 1.058 |
| lens (S1) | | | | | | |
| Intermediate | Asphere | 30.000 | 0.085 | — | — | 1.002 |
| lens (S2) | | | | | | |
| Diffusion | Sphere | infinity | TBD | — | — | 0.512 |
| unit | | | | | | |
| (diffuser) | | | | | | |
| Air | Sphere | infinity | 0.252 | — | — | 2.000 |
| Rear lens | Asphere | 22.550 | 2.200 | 1.497 | 81.55 | 0.518 |
| (S3) | | | | | | |
| Rear lens | Asphere | −18.902 | 9.470 | — | — | 0.604 |
| (S4) | | | | | | |
| Reflection | Sphere | infinity | 10.768 | — | — | 1.573 |
| unit (mirror) | | | | | | |
| Light | Sphere | infinity | 0 | — | — | 2.001 |
| modulator | | | | | | |
| (DMD) | | | | | | |

TABLE 12

| | Intermediate | Intermediate | | |
|---|---|---|---|---|
| Parameter Name | lens (S1) | lens (S2) | Rear lens (S3) | Rear lens (S4) |
| Y Radius | 3.863983 | 30 | 22.55015 | −18.9019 |
| Conic constant (K) | −13.4475 | 200 | 0 | −3.71065 |
| 4th order coefficient (A) | 0.019101 | −0.00575 | −8.93E−05 | −0.00077 |
| 6th order coefficient (B) | 0.033624 | 0.045979 | −0.00028 | 9.28E−05 |
| 8th order coefficient (C) | 0.004696 | 0.000168 | 7.69E−05 | −1.17E−05 |
| 10th order coefficient (D) | −0.00513 | 0.000644 | −1.12E−05 | −3.91E−06 |
| 12th order coefficient (E) | −2.42E−03 | −7.31E−04 | 6.01E−07 | 6.95E−07 |
| 14th order coefficient (F) | −1.24E−03 | −1.65E−03 | 0 | 0 |
| 16th order coefficient (G) | −3.68E−04 | −3.16E−03 | 0 | 0 |
| 18th order coefficient (H) | 4.49E−04 | −5.82E−03 | 0 | 0 |
| 20th order coefficient (J) | 1.00E−03 | 7.22E−03 | 0 | 0 |

Here, a thickness of a left- or light source-side surface of each of the intermediate lens and the rear lens refers to a thickness (related to a refractive index, an Abbe number, and the like) of each of the intermediate lens and the rear lens. A thickness of a right- or light modulator-side surface of each of the intermediate lens and the rear lens refers to a separation distance from a subsequent component. In addition, the term “Air” refers to an additional separation distance between two adjacent elements. Accordingly, a separation distance between the diffusion unit and the rear lens may be 0.252 mm or more. Furthermore, the units for thickness and length may be millimeters (mm). In addition, a thickness of each of the diffusion unit and the reflection unit refers to a separation distance from a component at the rear end or a thickness of the corresponding component. According to the embodiment, as a radius of curvature (or an absolute value of the radius of curvature) of the light source-side surface S1 of the intermediate lens 230 increases, a separation distance between the light source unit 220 and the intermediate lens 230 may decrease. In other words, when the separation distance between the light source unit 220 and the intermediate lens 230 is minimized, the radius of curvature (or the absolute value of the radius of curvature) of the light source-side surface S1 of the intermediate lens 230 may be infinite. Alternatively, when the separation distance between the light source unit 220 and the intermediate lens 230 is minimized, the light source-side surface S1 of the intermediate lens 230 may be flat or planar. In addition, the light source-side surface S1 of the intermediate lens 230 may be perpendicular to an optical axis. With this configuration, the separation distance between the light source unit and the reflection unit may be reduced, thereby enabling miniaturization of the illuminating system or the projection device. As such, the absolute value of the radius of curvature of the light source-side surface S1 of the intermediate lens 230 may be infinite. In addition, a separation distance D1 between the light source unit 220 and the intermediate lens 230 may be smaller than a separation distance D7 between the rear lens 250 and the reflection unit 260. In the present specification, the separation distance refers to a spacing between facing surfaces. In addition, the radius of curvature of the light source-side surface S1 of the intermediate lens 230 may be infinite when its absolute value is greater than or equal to 60. Accordingly, as described above, the separation distance between the light source unit and the reflection unit may be reduced, thereby achieving miniaturization of the illuminating system or the projection device.

In addition, the light source-side surface S1 of the intermediate lens 230 may be convex or concave toward the light source unit 220. As shown in Table 1, the light source-side surface S1 of the intermediate lens 230 may be convex toward the light source.

Furthermore, the reflection unit-side surface S2 of the intermediate lens 230 may be convex or concave toward the light source unit 220. In other words, the reflection unit-side surface S2 of the intermediate lens 230 may be concave or convex toward the reflection unit 260. In the present embodiment, the reflection unit-side surface S2 of the intermediate lens 230 may be convex toward the light source unit 220.

In addition, when a radius of curvature of the reflection unit-side surface S2 of the intermediate lens 230 decreases, the separation distance between the light source unit 220 and the intermediate lens 230 may decrease. In this case, the radius of curvature of the reflection unit-side surface S2 of the intermediate lens 230 may be positive (+).

Further, when the reflection unit-side surface S2 of the intermediate lens 230 is convex toward the light source unit 220, the separation distance D1 between the light source unit 220 and the intermediate lens 230 may be 3 mm or less. In addition, an absolute value of the radius of curvature of the reflection unit-side surface S2 of the intermediate lens 230 may be 3 or less. Accordingly, a miniaturized projection device may be provided.

Furthermore, a volume of the projection device (from the light source unit to a projection lens unit, including the illuminating system & the projecting system) may be 4 cc or less. Preferably, a minimum volume of the projection device (from the light source unit to the projection lens unit, including the illuminating system & the projecting system) may be 3 cc. The volume of the projection device (from the light source unit to the projection lens unit, including the illuminating system & the projecting system) or a total volume of the projection device may correspond to a volume of the housing.

In addition, a volume of the illuminating system (from the light source unit to the light modulator) may be 60% or less of the total volume of the projection device. For example, the volume from the light source unit to the light modulator may be less than equal to 2 cc.

In addition, in the illuminating system, among separation distances between components from the light source unit to the reflection unit, a distance D7 between the rear lens 250 and the reflection unit 260 may be the greatest. That is, the distance D7 from the rear lens 250 to the reflection unit 260 may be greater than each of a distance D2 between the light source unit 220 and the intermediate lens 230, a distance D3 between the intermediate lens 230 and the diffusion unit 240, and a distance D5 between the diffusion unit 240 and the rear lens 250.

Further, a distance between the reflection unit 260 and the light modulator 280 may be greater than the distance D7 between the rear lens 250 and the reflection unit 260.

In addition, among the separation distances between the components from the light source unit to the reflection unit in the illuminating system, the separation distance D1 between the light source unit 220 and the intermediate lens 230 may be the second largest after the distance D7 between the rear lens 250 and the reflection unit 260.

For example, the separation distance D1 between the light source unit 220 and the intermediate lens 230 may be greater than the distance between the reflection unit 260 and the light modulator 280.

In addition, among the separation distances between components in the illuminating system, the distance D3 between the intermediate lens 230 and the diffusion unit 240 may be the smallest. Thus, the separation distance D3 between the reflection unit-side surface S2 of the intermediate lens 230 and the diffusion unit 240 may be smaller than the separation distance D5 between the diffusion unit 240 and the rear lens 250.

Further, a thickness D2 of the intermediate lens 230 may be smaller than a thickness D6 of the rear lens 250. In addition, a refractive index of the intermediate lens 230 may be greater than a refractive index of the rear lens 250. Further, the Abbe number of the rear lens 250 may be greater than the Abbe number of the intermediate lens 230.

In addition, in the embodiment, the reflection unit-side surface S2 of the intermediate lens 230 may be disposed apart from the diffusion unit 240. For example, the separation distance D3 between the diffusion unit 240 and the reflection unit-side surface S2 of the intermediate lens 230 may be in a range of 15 μm to 100 μm.

In addition, the separation distance D3 between the reflection unit-side surface S2 of the intermediate lens 230 and the diffusion unit 240 may be smaller than the separation distance D5 between the diffusion unit 240 and the rear lens 250.

Further, the light source-side surface S1 of the intermediate lens 230 may be convex or concave toward the light source unit 220. In the embodiment, the light source-side surface S1 of the intermediate lens may be convex toward the light source unit 220.

Further, the reflection unit-side surface S2 of the intermediate lens 230 may be concave toward the light modulator 280 or the reflection unit 260. In other words, the reflection unit-side surface S2 of the intermediate lens may be convex toward the light source unit 220.

In addition, the light source-side surface S3 of the rear lens 250 may be convex toward the light source unit 220. In addition, the reflection unit-side surface S4 of the rear lens may be convex toward the light modulator or the reflection unit. With this configuration, miniaturization of the reflection unit 260 may be achieved, and distance adjustment may be easily performed in response to illumination performance.

Furthermore, the rear lens 250 may be provided as a plurality of rear lens 250, or an additional lens may be further disposed between the rear lens 250 and the reflection unit 260.

In addition, an optical axis OX of the light emitted from the light source unit 220 may form an angle θa of 42° to 48° with a reflective surface of the reflection unit 260. For example, the angle may correspond to a reflection angle of the light at the reflection unit 260. With this configuration, the miniaturization may be more easily achieved. In addition, the angle formed between the optical axis OX and the reflective surface of the reflection unit 260 may be adjusted according to a refractive index of the prism 270. The optical axis OX may be parallel to the first direction.

A distance (D6+D7) from the light source-side surface S3 of the rear lens to the reflection unit 260 may be in a range of 5 mm to 12 mm. When the distance (D6+D7) from the light source-side surface S3 of the rear lens to the reflection unit 260 is reduced to less than 5 mm, there is a limitation in which assembly is difficult. In addition, when the distance (D6+D7) from the light source-side surface S3 of the rear lens to the reflection unit 260 is 12 mm or more, there is a limitation in achieving miniaturization.

Further, in the present embodiment, an effective diameter (semi-aperture) of the intermediate lens 230 may be greater than an effective diameter of the rear lens 250. Furthermore, the light source-side surface S1 of the intermediate lens 230 may be convex toward the light source unit 220, and an effective diameter of the light source-side surface S1 of the intermediate lens 230 may be greater than an effective diameter of the reflection unit-side surface S2.

In addition, in the rear lens 250, an effective diameter of the light source-side surface S3 may be smaller than an effective diameter of the reflection unit-side surface S4.

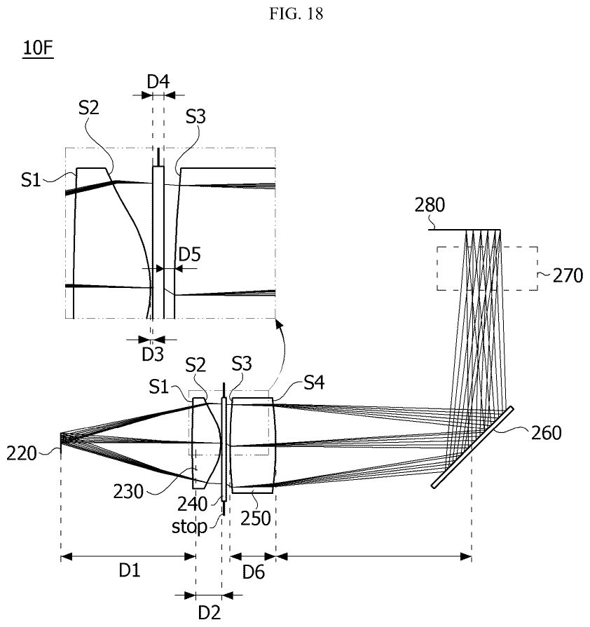

FIG. 18 is an optical system for an illuminating system in a projection device according to a seventh embodiment of the present invention.

Referring to FIG. 18, in the projection device according to the seventh embodiment, an optical system 10F may include, as described above, a light source unit 220 from which light is emitted, an intermediate lens 230, a diffusion unit 240, a rear lens 250, a reflection unit 260, an additional lens 263, and a prism 270, and a light modulator 280, on which light is incident and which is located at the rear end of the prism 270, may correspond to an image in the optical system. In the present projection device, a position of a stop is located between the light source unit 220 and the light modulator 280, and in particular, the diffusion unit 240 may be disposed at the position of the stop. Furthermore, except for the content described later, the above-described content of the projection device may be equally applied.

Furthermore, in the projection device according to the seventh embodiment, the contents described in Table 13 (component information) and Table 14 (aspheric surface data) may be applied to each component.

TABLE 13

| Element or | Surface | | | | | semi- |
|---|---|---|---|---|---|---|
| surface | type | Y Radius | Thickness | Index | Abbe | aperture |
| Light source | Sphere | infinity | 2.553 | — | — | 0.500 |
| unit | | | | | | |
| Intermediate | Asphere | infinity | 0.427 | 1.6188 | 63.85 | 1.584 |
| lens (S1) | | (flat) | | | | |
| Intermediate | Asphere | −1.757 | 0.020 | — | — | 2.050 |
| lens (S2) | | | | | | |
| Diffusion | Sphere | infinity | TBD | — | — | 2.000 |
| unit | | | | | | |
| (diffuser) | | | | | | |
| Air | Sphere | infinity | 0.252 | — | — | 2.000 |
| Rear lens | Asphere | 22.550 | 2.200 | 1.497 | 81.55 | 2.023 |
| (S3) | | | | | | |
| Rear lens | Asphere | −18.902 | 9.470 | — | — | 2.070 |
| (S4) | | | | | | |
| Reflection | Sphere | infinity | 10.768 | — | — | 2.437 |
| unit (mirror) | | | | | | |
| Light | Sphere | infinity | 0 | — | — | 2.014 |
| modulator | | | | | | |
| (DMD) | | | | | | |

TABLE 14

| | Intermediate | Intermediate | | |
|---|---|---|---|---|
| Parameter Name | lens (S1) | lens (S2) | Rear lens (S3) | Rear lens (S4) |
| Y Radius | infinity | −1.75727 | 22.55015 | −18.9019 |
| Conic constant (K) | — | −24.148 | 0 | −3.71065 |
| 4th order coefficient (A) | — | −0.43288 | −8.93E−05 | −0.00077 |
| 6th order coefficient (B) | — | 0.77621 | −0.00028 | 9.28E−05 |
| 8th order coefficient (C) | — | −0.85831 | 7.69E−05 | −1.17E−05 |
| 10th order coefficient | — | 0.271512 | −1.12E−05 | −3.91E−06 |
| (D) | | | | |
| 12th order coefficient | — | 3.21E−01 | 6.01E−07 | 6.95E−07 |
| (E) | | | | |
| 14th order coefficient | — | −1.70E−01 | 0 | 0 |
| (F) | | | | |
| 16th order coefficient | — | −1.33E−01 | 0 | 0 |
| (G) | | | | |
| 18th order coefficient | — | 7.43E−02 | 0 | 0 |
| (H) | | | | |
| 20th order coefficient (J) | — | 6.74E−03 | 0 | 0 |

Here, a thickness of a left- or light source-side surface of each of the intermediate lens and the rear lens refers to a thickness (related to a refractive index, an Abbe number, and the like) of each of the intermediate lens and the rear lens. A thickness of a right- or light modulator-side surface of each of the intermediate lens and the rear lens refers to a separation distance from a subsequent component. In addition, the term “Air” refers to an additional separation distance between two adjacent elements. Accordingly, a separation distance between the diffusion unit and the rear lens may be 0.252 mm or more. Furthermore, the units for thickness and length may be millimeters (mm). In addition, a thickness of each of the diffusion unit and the reflection unit refers to a separation distance from a component at the rear end or a thickness of the corresponding component. A light source-side surface S1 of the intermediate lens 230 may be flat or planar, with a radius of curvature that is infinite. Accordingly, a reflection unit-side surface S2 of the intermediate lens 230 may be convex toward the reflection unit 260. In other words, the reflection unit-side surface S2 of the intermediate lens 230 may be concave toward the light source unit 220. In addition, in the present embodiment, among separation distances between components in the illuminating system from the light source unit to the reflection unit, a distance D7 between the rear lens 250 and the reflection unit 260 may be the greatest. Thus, the distance D7 from the rear lens 250 to the reflection unit 260 may be greater than each of a distance D2 between the light source unit 220 and the intermediate lens 230, a distance D3 between the intermediate lens 230 and the diffusion unit 240, and a distance D5 between the diffusion unit 240 and the rear lens 250.

Further, a distance between the reflection unit 260 and the light modulator 280 may be greater than the distance D7 between the rear lens 250 and the reflection unit 260.

In addition, among separation distances between components from the light source unit to the reflection unit in the illuminating system, a separation distance D1 between the light source unit 220 and the intermediate lens 230 may be the second largest after the distance D7 between the rear lens 250 and the reflection unit 260. However, the separation distance D1 between the light source unit 220 and the intermediate lens 230 may be ⅓ or 0.33 times or less than the distance D7 between the rear lens 250 and the reflection unit 260. As such, the separation distance D1 between the light source unit 220 and the intermediate lens 230 may be minimized through shapes of the light source-side surface S1 and the reflection unit-side surface S2 of the intermediate lens 230. Thus, the miniaturization of the projection device may be realized.

In addition, among the separation distances between components in the illuminating system, the distance D3 between the intermediate lens 230 and the diffusion unit 240 may be the smallest. The separation distance D3 between the reflection unit-side surface S2 of the intermediate lens 230 and the diffusion unit 240 may be smaller than the separation distance D5 between the diffusion unit 240 and the rear lens 250.

Further, the reflection unit-side surface S2 of the intermediate lens may be convex toward the light modulator 280 or the reflection unit 260. In other words, the reflection unit-side surface S2 of the intermediate lens may be concave toward the light source unit 220. With this configuration, red (R), green (G), and blue (B) light may be effectively provided to the reflection unit 260 in a state of being mixed into white light.

Further, in the present embodiment, an effective diameter (semi-aperture) of the light source-side surface S1 of the intermediate lens 230 may be smaller than an effective diameter of the rear lens 250. Furthermore, the light source-side surface S1 of the intermediate lens 230 may be planar, and the reflection unit-side surface S2 may be convex toward the reflection unit, so that an effective diameter of the light source-side surface S1 of the intermediate lens 230 may be smaller than an effective diameter of the reflection unit-side surface S2.

In addition, in the rear lens 250, an effective diameter of a light source-side surface S3 may be smaller than an effective diameter of a reflection unit-side surface S4. Further, the effective diameter of the reflection unit-side surface S4 of the rear lens 250 may be greater than the effective diameter of the reflection unit-side surface S2 of the intermediate lens 230. In addition, the effective diameter of the reflection unit-side surface S2 of the intermediate lens 230 may be greater than the effective diameter of the light source-side surface S3 of the rear lens 250.

Features, structures, effects, and the like described in the above embodiments are included in at least one embodiment, and are not necessarily limited to only one embodiment. Furthermore, features, structures, effects, and the like illustrated in each embodiment can be combined or modified for other embodiments by those of ordinary skill in the art to which the embodiments belong. Accordingly, the contents related to such combinations and modifications should be interpreted as being included in the scope of the embodiments.

Although the embodiments have been described above, the embodiments are merely examples and not intended to limit the present invention and it may be seen that a variety of modifications and applications not described above may be made by one of ordinary skill in the art without departing from the essential features of the embodiments. For example, each component specifically shown in the embodiment may be implemented with modifications. In addition, it should be construed that differences related to such changes and applications are included in the scope of the embodiments defined in the appended claims.

1. A projection device comprising:
a light source unit;
a light modulator configured to modulate light emitted from the light source unit;
a diffusion unit disposed between the light source unit and the light modulator;
an intermediate lens disposed between the diffusion unit and the light source unit; and
a rear lens disposed between the diffusion unit and the light modulator,
wherein a position of a stop is located between the light source unit and the light modulator.

2. The projection device of claim 1, wherein the diffusion unit is disposed at or adjacent to the position of the stop.

3. The projection device of claim 1, comprising:
a reflection unit disposed between the rear lens and the light modulator; and
a prism disposed between the light modulator and the reflection unit.

4. The projection device of claim 3, wherein
the intermediate lens includes a first surface facing the light source unit and a second surface facing the light modulator, and
the rear lens includes a third surface facing the light source unit and a fourth surface facing the light modulator.

5. The projection device of claim 4, wherein the second surface is disposed apart from the diffusion unit.

6. The projection device of claim 4, wherein a separation distance between the second surface and the diffusion unit is smaller than a distance between the diffusion unit and the rear lens.

7. The projection device of claim 4, wherein the first surface is convex or concave toward the light source unit.

8. The projection device of claim 4, wherein the second surface is convex toward the light modulator.

9. The projection device of claim 4, wherein a size of a radius of curvature of the first surface is greater than a size of a radius of curvature of the second surface.

10. The projection device of claim 4, wherein the third surface is convex toward the light source unit.

11. The projector device of claim 4,
wherein the fourth surface is convex toward the light modulator.

12. The projector device of claim 4,
wherein an optical axis of light emitted from the light source unit forms an angle of 42° to 48° with a reflective surface of the reflection unit.

13. The projector device of claim 4,
wherein a distance from the light source unit to the second surface is in a range of 5.5 mm to 9 mm.

14. The projector device of claim 4,
wherein a distance from the third surface to the reflection unit is in a range of 5 mm to 12 mm.

15. The projector device of claim 4,
wherein a distance from the fourth surface to the reflection unit is greater than a distance from the light source unit to the first surface or from the light source unit to the second surface.

16. The projector device of claim 3,
wherein the reflection unit is inclined at a predetermined angle with respect to the rear lens.

17. The projector device of claim 3,
wherein the reflection unit is configured to reflect light toward a projection lens unit.

18. The projector device of claim 3, comprising an additional lens disposed at a rear side of the reflection unit.

19. The projector device of claim 18,
wherein the additional lens is disposed below the reflection unit.

20. The projector device of claim 18,
wherein the additional lens at least partially overlaps in one direction with the reflection unit.
